(19) United States
(12) Patent Application Publication
(10) Pub. No.: US 2026/0197515 A1
(43) Pub. Date: Jul. 9, 2026

(54) METHODS AND SYSTEMS OF PROVISIONING DIGITAL CONTENT

(71) Applicant: Neotericc LLC, LONE TREE, CO (US)

(72) Inventor: Patrick L. Carter, Lone Tree, CO (US)

(73) Assignee: Neotericc LLC, LONE TREE, CO (US)

(21) Appl. No.: 19/433,956

(22) Filed: Dec. 28, 2025

Related U.S. Application Data
(60) Provisional application No. 63/739,119, filed on Dec. 27, 2024.
(60) Provisional application No. 63/754,579, filed on Feb. 6, 2025.

(51) Int. Cl. H04N 21/2662; H04N 21/234; H04N 21/239; H04N 21/242; H04N 21/482; H04N 21/8549

(52) U.S. Cl. CPC H04N 21/2662; H04N 21/23418; H04N 21/2393; H04N 21/242; H04N 21/482; H04N 21/8549

(57) ABSTRACT

The present disclosure provides a method of provisioning digital content. Further, the method may include receiving, using a communication device, a content stream data from one or more content source devices. Further, the receiving may be performed based on a real-time communication protocol. Further, the method may include generating, using the processing device, an adaptive content stream data based on the one or more content stream data in accordance with an adaptive bitrate streaming protocol. Further, the method may include transmitting, using the communication device, the adaptive content stream data to one or more user devices associated with one or more users.

### REFERENCE TO RELATED APPLICATIONS

This application claims the benefit of U.S. Provisional Patent Application No. 63/739,119, titled “METHODS AND SYSTEMS OF PROVISIONING DIGITAL CONTENT”, filed on Dec. 27, 2024; and U.S. Provisional Patent Application No. 63/754,579, titled “SYSTEMS AND METHODS OF FACILITATING A VIDEO STREAM BROADCASTING, filed on Feb. 6, 2025, each of which is incorporated by reference herein in its entirety.

### FIELD OF DISCLOSURE

The present disclosure relates to the field of data processing. More specifically, the present disclosure relates to methods and systems of provisioning digital content.

### BACKGROUND

The present disclosure generally relates to the field of digital media processing, and more particularly to systems and methods for real-time handling, analysis, and delivery of media streams in collaborative and broadcast environments. The field of digital media processing plays an increasingly important role in modern communication, remote collaboration, live broadcasting, interactive entertainment, training, and analytics-driven content consumption, where media content is no longer passively viewed but actively interacted with by multiple participants across distributed computing environments. As reliance on networked media platforms continues to expand, the ability to process, coordinate, and deliver media in a manner that is responsive to user interactions and contextual demands has become critical to ensuring effective communication, engagement, and decision-making.

A desirable objective in the field is to facilitate intelligent, real-time coordination and presentation of media content in a manner that adapts to collaborative context, evolving session conditions, and diverse playback requirements, while maintaining compatibility with existing delivery infrastructures and playback environments. Achieving the above objective may allow media experiences to be more responsive, interactive, and informative for users participating in live sessions or consuming recorded content, thereby enhancing the overall utility and effectiveness of media-based collaboration and broadcasting.

However, existing approaches for handling collaborative media streams and enhanced playback often encounter significant limitations when attempting to achieve this objective. Many known solutions rely on static configurations or predefined control logic that do not adequately adapt to dynamic changes in user interaction, session context, or media content characteristics. Such rigidity may result in inefficient use of network and processing resources, suboptimal presentation of relevant content, and delayed or inappropriate responses to events occurring within a media stream. Additionally, known systems frequently struggle to manage multiple concurrent media sources in a coordinated manner, leading to synchronization issues, fragmented user experiences, and reduced coherence across views.

Further, existing solutions for augmenting media playback with analytical or contextual information may introduce compatibility challenges, excessive transmission overhead, or limited interactivity, thereby constraining the practical deployment across heterogeneous client devices and playback environments. In collaborative scenarios, the limitations may be compounded by difficulties in maintaining consistent session state, supporting flexible replay or review of prior interactions, and accommodating diverse user roles or perspectives. As a result, current technologies may fall short in providing a scalable, adaptable, and context-aware framework for real-time collaborative media orchestration and enriched media playback.

Therefore, there is a need for improved methods and systems for facilitating intelligent, real-time collaborative media orchestration and enhanced media playback that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of provisioning digital content. Further, the method may include receiving, using a communication device, a content stream data from one or more content source devices. Further, the receiving may be performed based on a real-time communication protocol. Further, the method may include generating, using the processing device, an adaptive content stream data based on the one or more content stream data in accordance with an adaptive bitrate streaming protocol. Further, the method may include transmitting, using the communication device, the adaptive content stream data to one or more user devices associated with one or more users.

The present disclosure provides a system for provisioning digital content. Further, the system may include a communication device. Further, the communication device may be configured for receiving a content stream data from one or more content source devices. Further, the receiving may be performed based on a real-time communication protocol. Further, the communication device may be configured for transmitting an adaptive content stream data to one or more user devices associated with one or more users. Further, the system may include a processing device communicatively coupled with the communication device. Further, the processing device may be configured for generating the adaptive content stream data based on the one or more content stream data in accordance with an adaptive bitrate streaming protocol.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

The drawings presented with this disclosure may illustrate representative and non-limiting arrangements of hardware components, software modules, artificial intelligence subsystems, machine learning architectures, data processing pipelines, user interfaces, network topologies, and memory arrangements that may be used to understand embodiments of the present subject matter. They may depict functional or conceptual layouts intended to facilitate explanation of the disclosed principles. The geometric appearance, dimensional proportions, ordering, grouping, and naming of elements within the drawings are not intended to imply any restriction on implementation. The drawings may schematically portray computing environments containing client devices, servers, distributed computing clusters, communication networks, storage systems, or artificial intelligence models arranged for training, inference, or combined operations. The drawings may include simplified symbolic representations of algorithmic processes, workflows, blocks, or modules; such symbolic representations are treated as abstractions of underlying hardware and software operations rather than literal structural requirements. Similarly, lines connecting components may represent logical associations, communication pathways, or data relationships rather than any specific physical wiring or layout. These figures may also illustrate non-exhaustive examples of operational stages, sequencing, or interactions among artificial intelligence components such as encoders, decoders, generators, discriminators, featurizers, transformers, or safety-validation modules. Any specific combination or configuration shown is presented for explanatory clarity only. Additional drawings, alternative views, or more granular depictions may be used without affecting the scope of the claims.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 is a block diagram illustrating a machine-learning system 300 for implementing various embodiments of this disclosure, in accordance with some embodiments.

FIG. 4 illustrates a flowchart of a method 400 of provisioning digital content, in accordance with some embodiments.

FIG. 5 illustrates a flowchart of a method 500 of provisioning digital content including determining, using the processing device 1204, a plurality of time information, in accordance with some embodiments.

FIG. 6 illustrates a flowchart of a method 600 of provisioning digital content including generating, using the processing device 1204, a control command data using the at least one AI agent module, in accordance with some embodiments.

FIG. 7 illustrates a flowchart of a method 700 of provisioning digital content including retrieving, using a storage device 1302, a contextual data from a database, in accordance with some embodiments.

FIG. 8 illustrates a flowchart of a method 800 of provisioning digital content including generating, using the processing device 1204, an annotation data using the at least one AI agent module, in accordance with some embodiments.

FIG. 9 illustrates a flowchart of a method 900 of provisioning digital content including generating, using the processing device 1204, at least one customized adaptive content stream data using the at least one AI agent module, in accordance with some embodiments.

FIG. 10 illustrates a flowchart of a method 1000 of provisioning digital content including retrieving, using a storage device 1302, at least one recap data from the adaptive content stream data, in accordance with some embodiments.

FIG. 11 illustrates a flowchart of a method 1100 of provisioning digital content including generating, using the processing device 1204, at least one recap summary data using the at least one AI agent module, in accordance with some embodiments.

FIG. 12 illustrates a block diagram of a system 1200 of provisioning digital content, in accordance with some embodiments.

FIG. 13 illustrates a block diagram of the system 1200 of provisioning digital content, in accordance with some embodiments.

FIG. 14 illustrates a block diagram of the system 1200 for provisioning digital content, in accordance with some embodiments.

FIG. 15 illustrates a flowchart of a method 1500 of provisioning digital content including identifying, using the processing device 1204, at least one missed content stream data, in accordance with some embodiments.

FIG. 16 illustrates a flowchart of a method 1600 of provisioning digital content including generating, using the processing device 1204, at least one missed content summary data, in accordance with some embodiments.

FIG. 17 illustrates a flowchart of a method 1700 of facilitating a video stream broadcasting, in accordance with some embodiments.

FIG. 18 illustrates a flowchart of a method 1800 of facilitating a video stream broadcasting including encoding, using the processing device 1904, the embedded content stream data to obtain an encoded embedded content stream data, in accordance with some embodiments.

FIG. 19 illustrates a block diagram of a system 1900 of facilitating a video stream broadcasting, in accordance with some embodiments.

FIG. 20A illustrates a flowchart of a method 2000 of facilitating a video stream broadcast, in accordance with some embodiments.

FIG. 20B illustrates a continuation of the flowchart of the method 2000 of facilitating a video stream broadcast, in accordance with some embodiments.

FIG. 21 illustrates a block diagram of a system 2100 of facilitating a video stream broadcast, in accordance with some embodiments.

FIG. 22 illustrates a block diagram of the system 2100 of facilitating a video stream broadcast, in accordance with some embodiments.

FIG. 23A illustrates a flowchart of a method 2300 of providing a multi-stream situation room interface, in accordance with some embodiments.

FIG. 23B illustrates a continuation of the flowchart of the method 2300 of providing a multi-stream situation room interface, in accordance with some embodiments.

FIG. 24 illustrates a block diagram of a system 2400 of providing a multi-stream situation room interface, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

The detailed description that follows may provide a framework for describing computer-implemented systems, artificial intelligence systems, distributed learning infrastructures, data processing pipelines, and hardware and software arrangements suitable for implementing embodiments shown in the drawings. Terms such as processing, computing, determining, or generating refer to actions performed by computing systems or electronic devices that manipulate data represented as physical signals, stored values, or encoded information within registers, memory structures, and storage devices.

The present disclosure contemplates implementations involving artificial intelligence, machine learning, distributed computation, and computer-implemented systems operating upon data represented as physical electronic or optical signals. Descriptions of processing, analyzing, determining, transforming, encoding, decoding, generating, inferring, synthesizing, modifying, storing, retrieving, ranking, filtering, validating, classifying, or otherwise manipulating information are to be understood as referring to the actions of computing systems, electronic devices, or computational circuits that manipulate such signals in memory elements, registers, buffers, or storage media. These operations may be performed by general-purpose processors, specialized processors, machine learning accelerators, or combinations thereof.

The disclosure contemplates implementations in which artificial intelligence systems perform perception, synthesis, inference, prediction, or generation of information using models whose configurations may evolve based on training, feedback, or adaptive learning processes. A model may initially be configured with a set of parameters and architectural structures that define its behavior, and this configuration may change automatically as the model encounters training inputs, validation data, reference data, or instructor-provided feedback. A machine learning model may modify its internal state through optimization techniques, gradient updates, reinforcement signals, vector transformations, attention mechanisms, latent variable adjustments, embedding refinements, or other learning operations executed electronically. Such modifications may occur over extended cycles, partial cycles, or continual learning sequences without explicit intervention by a human.

The disclosure contemplates systems involving data ingestion pipelines that gather input from sources including but not limited to sensor signals, event streams, text data, image data, audio data, video data, structured and unstructured repositories, application logs, telemetric feeds, network services, or human-generated content. Ingestion functions may include filtering, normalization, augmentation, segmentation, batching, tokenization, windowing, compression, encryption, decryption, hashing, deduplication, contextualization, and mapping to internal formats. Intermediate components may transform this data into derived representations, including embeddings, latent encodings, feature tensors, multi-modal joint representations, or contextual vectors suitable for use by downstream modeling engines. These transformations may be performed using neural networks, statistical encoders, dimensionality-reduction algorithms, or hybrid computational modules.

The disclosure contemplates machine learning systems that may employ advanced architectures such as transformer networks, encoder-decoder stacks, mixture-of-experts structures, diffusion models, recurrent networks, convolutional hierarchies, attention-based models, retrieval-augmented architectures, cross-modal alignment engines, graph neural networks, probabilistic models, auto-encoding frameworks, or hybrid symbolic-neural systems. Such models may implement deep layers configured to perform operations including attention calculations, feed-forward projections, gating operations, positional encoding, normalization steps, multi-head routing, sequential decoding, or latent pathway selection. Multi-modal systems may combine textual, visual, auditory, sensory, or structured inputs within joint representational spaces. Embeddings may be learned from large corpora or multi-modal datasets and may encode semantic, syntactic, structural, temporal, spatial, or contextual relationships across modalities. These embeddings may be dynamically updated as the system encounters new information, thereby improving consistency, expressiveness, or alignment with real-world contexts.

The disclosure contemplates training processes that may involve supervised learning, unsupervised learning, semi-supervised learning, self-supervised learning, reinforcement learning, preference optimization, curriculum-based learning, active learning, or continual learning. Training operations may include forward passes through the model, backward propagation of gradients, update steps using optimization algorithms, adaptive learning-rate scheduling, regularization steps, loss-function evaluation, and checkpointing of intermediate states. Training datasets may include real-world data, synthetic data, simulated data, augmented data, or mixtures thereof. Validation procedures may evaluate performance metrics, generalization behavior, safety constraints, or compliance with domain-specific criteria. In some implementations, refinement cycles may incorporate human-in-the-loop interventions, reward model shaping, safety evaluator feedback, or guided corrections.

The disclosure contemplates distributed or federated execution in which computation is partitioned across multiple hardware devices, regions, or clusters. Certain operations may occur at edge devices for low latency, while others may be delegated to remote servers, cloud clusters, datacenters, or specialized compute fabrics. Components may communicate over wired or wireless networks supporting data exchange, synchronization, replication, or model-state updates. Distributed learning processes may synchronize gradients, coordinate model versions, merge updates across shards, or exchange activation values within parallel training regimes. Distributed inference may involve routing requests across replicas, balancing load through orchestration layers, or selecting model pathways dynamically. Network connections may include encryption, authentication, secure session management, or routing protocols appropriate for maintaining privacy, integrity, or availability.

The disclosure contemplates orchestration layers capable of managing complex workflows involving model invocation, tool invocation, external data retrieval, decision routing, fallback selection, multi-model aggregation, post-processing evaluation, or safety governance. Orchestration environments may evaluate contextual signals, metadata, user characteristics, or policy constraints to determine which models, subsystems, or computational branches should be executed. Such environments may dynamically alter execution pathways based on estimated performance, resource availability, model confidence, safety risk, or real-time system health. Post-processing components may evaluate generated outputs for compliance with content policies, statutory requirements, operational constraints, or domain-specific decision rules.

The disclosure contemplates safety-oriented components that evaluate model outputs or intermediate representations for consistency with safety criteria, quality thresholds, regulatory considerations, factual accuracy constraints, domain restrictions, or alignment requirements. Safety modules may employ auxiliary models, discriminators, rule sets, statistical detectors, confidence estimators, or hybrid evaluators to identify undesirable outputs. These modules may trigger remediation actions including output modification, output rejection, re-routing through alternate inference pathways, invocation of corrective models, or escalation for human review. Safety processes may incorporate real-time validation, contextual scoring, adversarial robustness analysis, anomaly detection, or controlled generation constraints.

The disclosure contemplates governance structures including policy managers, audit loggers, compliance trackers, version controllers, and provenance systems that associate model outputs with contextual metadata, historical signals, update events, training sources, or safety evaluations. Systems may maintain lineage records documenting which model version, configuration state, or training dataset contributed to an outcome. Governance modules may ensure that system behavior aligns with formal requirements such as fairness principles, legal obligations, industry standards, or institutional guidelines.

The disclosure contemplates storage and memory systems capable of storing model parameters, datasets, embeddings, logs, metrics, checkpoints, execution traces, and auxiliary information used to configure or interpret model behavior. These storage systems may include magnetic media, semiconductor memory, optical media, solid-state arrays, distributed storage fabrics, or hybrid memory hierarchies. Storage media may contain instructions, configurations, or data structures that, when accessed by a computing device, configure that device to carry out the operations described herein. Such media may include executables, bytecode, machine code, firmware, microcode, program modules, configuration files, architectural descriptors, or schema definitions.

The disclosure contemplates user interfaces that permit human operators to view model outputs, initiate tasks, modify configurations, inspect metrics, interact with logs, evaluate safety signals, or guide system adaptation. Interfaces may be multimodal and may support textual input, speech commands, visual interaction, gesture control, or programmatic invocation through APIs. Administrative interfaces may allow for reviewing system performance, tuning operational thresholds, enabling or disabling features, monitoring resource use, examining generated content, or initiating refinement workflows.

The disclosure contemplates systems in which instructions are executed entirely on a single device, partially on multiple devices, or cooperatively across remote and local environments. Code may execute directly on hardware, within firmware, inside virtual machines, inside containers, or through any combination of software and hardware interactions. Computational instructions may be stored locally, transferred via communication networks, or streamed from remote systems. Implementations may involve software executing on general-purpose processors, specialized logic circuits performing equivalent functions, or hybrid mechanisms that combine hardware acceleration with software guidance.

Interpretation of terms in this disclosure is governed by principles commonly applied by persons of ordinary skill in the relevant field. Technical and scientific terms used herein should be understood in a manner consistent with their usage in the field of artificial intelligence, machine learning, computing, networking, data storage, or any related discipline. Terms describing functionality should not be interpreted as strictly structural unless explicitly stated. Phrases such as configured to, adapted to, operable to, or capable of indicate permissible functionality rather than structural limitations. Terms such as a or an encompass one or more unless clearly contradicted by context. Terms joined by or should be interpreted as inclusive, and terms joined by and should be interpreted as collective.

The description set forth herein provides a broad and flexible framework intended to support a wide range of computer-implemented, machine-learning-enabled, distributed, and multimodal embodiments. Variations may include reallocation of tasks, substitution of algorithms, reconfiguration of models, changes to pipeline ordering, or adoption of alternate hardware. No combination or arrangement mentioned herein should be regarded as required unless explicitly stated. The scope of protection is established by the claims, interpreted in light of this description.

The present disclosure contemplates implementations that employ advanced mathematical frameworks characteristic of modern artificial intelligence systems. Machine learning models may be conceptualized as parameterized functions that map elements of an input space to elements of an output space. Such a function may be defined over real-valued, complex-valued, vector-valued, tensor-valued, or mixed-modal domains. The model may implement successive transformations applied to an ordered set of input vectors using compositions of linear operators, nonlinear activations, attention functions, normalization operations, and dimensional projections.

Model parameters may be represented as ordered collections of real-valued scalars arranged into structures such as matrices, tensors, kernels, filters, or embeddings. These parameters may be optimized by minimizing a loss functional defined over an expected distribution of input-output pairs. The optimization process may involve computing gradients of the loss functional with respect to each model parameter, followed by an update step that serves to reduce the value of the loss functional. Gradient computation may use automatic differentiation frameworks that symbolically or numerically propagate partial derivatives backward through a computational graph.

Attention mechanisms may employ a similarity measure between projected query vectors and projected key vectors. This similarity measure may yield a weight distribution over contextual elements. The weighted combination of projected value vectors may form an attention output that is subsequently transformed through additional layers. Multiple independent attention heads may be aggregated to capture heterogeneous relationships within the input domain. Cross-attention mechanisms may operate similarly but with distinct source and target sequences.

Normalization steps may rescale intermediate representations using learned scaling and shifting coefficients. Activation functions may introduce nonlinearity by applying element-wise transformations selected to ensure differentiability and expressive capacity. Residual pathways may combine transformed and untransformed representations to facilitate stable gradient propagation under deep compositions. Positional encodings or structural embeddings may inject ordering, spatial, temporal, or relational information into otherwise permutation-invariant architectures.

Multi-modal models may operate over domains that combine text, image, audio, video, sensor, or structured signals. These domains may be embedded into a common vector space through learned projection operators. Joint training processes may enforce alignment constraints that minimize representational divergence between modalities while preserving intra-modal semantics.

Diffusion frameworks may model data generation as the reversal of a stochastic corruption process. A forward process may incrementally add noise to data samples, while a learned reverse process may approximate the time-reversed conditional probability distribution. The reverse process may be parameterized by a neural network trained to denoise intermediate states. Continuous-time formulations may model this process using stochastic differential equations whose drift and diffusion terms are learned through score-matching or related techniques.

Reinforcement-based procedures may model learning as an optimization of expected reward under a policy function. The policy may produce distributions over actions given a latent or explicit representation of the environment state. Policy gradients may be estimated from sampled trajectories, and advantage estimators may reduce variance of such gradients. Value functions may approximate the expected cumulative reward, and these approximations may be updated through temporal-difference learning.

Generative models may be expressed in probabilistic terms as joint or conditional distributions parameterized by neural architectures. Such models may perform sampling by iteratively drawing latent variables from a learned distribution and transforming those variables into output space. Variational models may introduce auxiliary latent variables whose posterior distributions are approximated through recognition functions that optimize an evidence-bound objective.

Matrix decompositions, spectral analysis, manifold learning, kernel operators, and other mathematical constructs may be incorporated to improve expressiveness, stability, or computational efficiency. Training may involve sophisticated schedulers, trust-region constraints, adaptive learning-rate schemes, gradient-norm clipping, regularization penalties, entropy maximization, attention masking, or mixed-precision arithmetic.

All such mathematical constructs are conceptual, descriptive, and non-limiting. The disclosure encompasses any differentiable or non-differentiable optimization method, any discrete or continuous learning paradigm, and any representational transformation that may be understood by a person of ordinary skill in the field.

Further, the disclosure provides a computing environment which may include a combination of client devices, servers, distributed computing clusters, databases, external data sources, network nodes, and interface endpoints. Such an environment may support artificial intelligence workloads including perception, synthesis, inference, prediction, and generation, using hardware and software foundations designed for high-throughput and low-latency operation. Embodiments may involve the coordinated use of multiple machine learning models, whose configurations may evolve over time as they learn from training, validation, reference, or feedback data. Models may adjust their internal parameters through supervised, unsupervised, or reinforcement-based processes, allowing automatic electronic improvements to their performance based on input data and observed outcomes.

Further, the disclosure provides a computing device which may include processing units, memory elements, storage devices, system buses, high-speed controllers, low-speed controllers, and expansion interfaces. Processors may include general-purpose units, multi-core processors, vector processors, digital signal processors, tensor accelerators, neural accelerators, graphics engines, or various kinds of specialized integrated circuits including FPGAs, ASICs, ASSPs, SoCs, and CPLDs. A device may include system memory composed of volatile or non-volatile components such as RAM, DRAM, flash memory, ROM, or phase-change memory. The storage subsystem may include solid-state drives, magnetic disks, optical media, arrays of storage devices, and network-attached storage resources. Input and output mechanisms may include microphones, displays, keyboards, pointing devices, biometric sensors, gesture or touch interfaces, and actuators suitable for multimodal interaction with a user.

Further, the disclosure provides a machine-learning architecture which may include engines or modules such as a data input engine, data retrieval engine, data transform engine, featurization engine, modeling engine, generative engine, validation engine, feedback engine, and refinement engine. A data input pipeline may obtain structured or unstructured information from various sources, transform the information into model-compatible forms, and store such transformed data in memory or storage accessible to downstream components. A modeling engine may perform tasks such as model training, re-configuration, validation, and testing, executing iterative processes across multiple cycles or passes through training data. A predictive or generative engine may construct outputs based on intermediate representations, learned embeddings, or latent encodings generated by layers such as encoder-decoder structures, attention mechanisms, or multi-layer transformer architectures. Embeddings may represent discrete entities such as words, documents, or images as continuous vectors in high-dimensional spaces, capturing semantic or structural relationships useful for downstream tasks.

Further, the disclosure may provide a distributed or cloud-based operation may include multiple physical or virtual instances of computing devices, distributed across data centers or network boundaries. Functions may be partitioned across machines to achieve parallelism, redundancy, fault tolerance, or improved throughput. Distributed systems may use load balancing mechanisms to maintain stable processing, memory, or bandwidth utilization across clusters and avoid overload conditions. Such deployments may require communication over wired or wireless networks that implement a variety of protocols including HTTP, HTTPS, MQTT, CoAP, or any other suitable communication framework. Communication channels may include local networks, wide-area networks, personal-area networks, or global communication systems, potentially utilizing secure encrypted sessions such as SSL-based channels.

Further, the disclosure may provide an algorithm, process, or flow diagram which may include operations that may occur in sequences, reversed orders, concurrently, or in partially overlapping timelines, depending on the implementation. Blocks representing actions in a flowchart may correspond to program modules, instruction sequences, or hardware logic capable of performing the specified acts. Such operations may manipulate physical quantities such as electrical or magnetic signals stored or transferred among memory units, registers, storage devices, or communication media. Flow diagrams may be realized through software running on general-purpose processors, through dedicated hardware circuits, or through combinations of both.

Further, the disclosure may provide memory, storage, or programmatic constructs which may include program instructions encoded on computer-readable media including electronic, magnetic, optical, electromagnetic, semiconductor, or other tangible media. Examples include RAM, ROM, EEPROM, flash memory, magnetic disks, optical disks, and mechanical encoded structures such as punch cards or raised-pattern media. Such storage media may store instructions that, when executed, configure the memory and therefore configure the computing device itself, causing the device to perform functions described in association with the drawings.

Further, the disclosure may provide a user interface which may include graphical displays, dashboards, selection controls, input fields, monitoring elements, or multimodal interaction surfaces, allowing users to interact with computing systems in speech, touch, gesture, or other modalities. Such interfaces may be presented through client devices, server applications, or remote access platforms and may support visualization of model behavior, systems performance, or configuration parameters.

Further, described features may be combined, rearranged, omitted, or substituted without departing from the principles disclosed. Variations may involve distributing functionality across devices, merging components, implementing features in hardware rather than software, or employing alternative communication protocols. Many such variations and modifications are intended to fall within the scope of the disclosure as understood by persons skilled in the art.

The detailed description of the drawings therefore provides a foundation for describing technical, architectural, and operational aspects of embodiments, while allowing broad flexibility in how such embodiments may be implemented in practice. The scope of such embodiments is governed by the claims rather than the illustrative content of the drawings.

In some embodiments, a system consistent with this disclosure includes one or more client devices, one or more servers, and one or more data stores coupled by one or more networks. The client devices can include, without limitation, mobile phones, tablet computers, laptop or desktop computers, wearable devices, smart displays, vehicles, robots, or other computing platforms equipped with data processing hardware and memory hardware. The servers can include data servers, application servers, web servers, proxy servers, or cloud computing services that provide shared processing, storage, and networking resources. The data stores can include databases, object stores, file systems, or other repositories that persist configuration data, training data, logs, model artifacts, and other information.

The networks can include public and private networks, such as local area networks, wide area networks, and cloud networks, using wired or wireless communication links. The networks can provide routing, addressing, access control, encryption, and related functionality using standard or proprietary protocols.

Each computing device, whether a client device or a server, can include one or more processors, system memory, persistent storage, communication interfaces, and input or output devices. The processors can include general purpose central processing units, graphics processing units, digital signal processors, microcontrollers, application specific integrated circuits, field programmable gate arrays, or other programmable or fixed function processing elements configured to execute instructions or perform logic operations. The memory can include volatile and non-volatile storage, such as random access memory and read only memory. The persistent storage can include solid state drives, magnetic disks, optical media, or other non-transitory computer readable media.

Program code executed by the processors can include operating systems, device drivers, libraries, and application programs, including components that implement portions of the methods described herein. Program code and data can be stored on computer readable media and loaded into memory by standard mechanisms, such as boot loaders, installation programs, or update services.

Input devices can include keyboards, pointing devices, microphones, cameras, touch sensitive surfaces, biometric sensors, and other sensors. Output devices can include displays, speakers, haptic devices, printers, and other actuators. Some devices can support multimodal interaction, allowing combined or sequential input and output through various modalities.

For purposes of this disclosure, artificial intelligence systems may include arrangements of software and hardware that perform tasks such as perception, prediction, planning, or generation based on input data. These systems can employ one or more models, such as statistical models, neural networks, decision trees, or other machine learning models. As used herein, a “model” can refer to a parameterized function, an ensemble of such functions, or a collection of cooperating components that process data and produce outputs.

In some embodiments, the system includes a data input engine that obtains data from one or more sources, such as application logs, sensor streams, structured databases, and unstructured content. The data input engine can retrieve, filter, aggregate, or transform the data into feature representations suitable for model consumption. Data sources can include training data, validation data, and reference data used to evaluate and calibrate model behavior.

A modeling engine can manage one or more training processes for one or more models. The modeling engine can select model architectures, initialize parameters, and apply training algorithms such as supervised learning, semi supervised learning, unsupervised learning, reinforcement learning, or combinations thereof. The modeling engine can also manage hyperparameters, training schedules, and evaluation procedures across epochs or passes through the data.

The system can include a generative response engine or inference engine that receives prompts or other inputs and generates outputs using one or more models. For example, a natural language interface can receive a text prompt, embed or otherwise encode the prompt, process the encoded prompt using a transformer based model or other sequence model, and generate a sequence of tokens that are decoded into an output. The engine can generate multiple candidate outputs and apply validation or ranking logic to select a final result according to quality, safety, or relevance criteria.

A feedback engine can collect explicit or implicit feedback signals, such as user ratings, corrective edits, or outcome metrics derived from downstream tasks. A refinement engine can use such feedback to adjust model parameters, routing logic, or policies, for example by performing additional training steps, updating reward models, or modifying configuration parameters.

In certain embodiments, the disclosed techniques are applied to platforms that include sensors and actuators, such as vehicles, robots, or other machines. The platform can include a processor system that receives signals from cameras, LIDAR units, radar units, inertial sensors, and other devices, and produces control outputs for steering, propulsion, braking, or other actuators. Sensor data can be captured at various sampling rates and processed by perception models to detect and track objects and infer scene attributes.

Planning and control components can receive outputs from perception models along with route information, traffic rules, and high level goals. These components can generate trajectories or control commands, optionally using reinforcement learned policies, optimization based planners, or hybrid systems. Connections to backend services can permit off board processing, fleet level learning, or remote supervision where appropriate, while on board components can maintain safe operation in the presence of network latency or failures.

The systems described herein can be implemented using centralized, decentralized, or hybrid arrangements. For instance, models may be deployed in cloud environments, on edge devices, or across both, depending on requirements such as latency, privacy, cost, and reliability. Load balancing and resource management components can distribute processing across devices or data centers and can provide elasticity to accommodate changing workloads.

Certain embodiments may expose functionality through application programming interfaces, software development kits, or graphical user interfaces. Client applications can submit requests to backend services, which can apply authentication, authorization, logging, and policy enforcement before invoking models or tools and returning results.

The systems and methods disclosed herein can be implemented in hardware, software, firmware, or any combination thereof. In some embodiments, operations are carried out by one or more processors executing program instructions stored on one or more non-transitory computer readable media. Such media can include, without limitation, semiconductor memory, magnetic storage, optical storage, and combinations thereof. Program instructions, when executed by the processors, cause the processors to perform the operations described herein.

Instructions can be delivered to computing devices in various ways, such as pre installation, physical distribution of media, or transmission over networks. Instructions received over a network can be stored in memory or persistent storage and then executed by one or more processors. Dedicated hardware logic, such as application specific integrated circuits or field programmable gate arrays, can be used alone or in combination with software to implement certain functionality.

Any methods described in connection with embodiments of the present disclosure can be represented as one or more flow diagrams or state diagrams. Blocks in such diagrams can correspond to modules, components, operations, or code segments that implement the associated functionality. Blocks can be reordered, combined, executed concurrently, or omitted according to implementation specific considerations, unless a particular ordering is required by the claims.

Examples and embodiments described herein illustrate, rather than limit, the claimed subject matter. Certain features have been described in connection with particular embodiments for clarity, but other embodiments can include such features in different combinations. Features described in separate embodiments can be combined, and features described in a single embodiment can be separated, unless such combinations or separations are inconsistent with the claims. The scope of the disclosure is defined by the claims and their equivalents.

### Overview

The present disclosure relates to AI-driven real-time collaboration systems. Methods and systems disclosed herein may encompass multi-channel media orchestration, dynamic video and data stream management, and intelligent event handling in multi-agent environments. Further, the disclosed method and system may also support live interaction, adaptive media streams, and asynchronous playback through integrated AI, real-time video feeds, historical media file access, and interactive visualizations. The methods and systems disclosed herein may be suitable for several applications. The applications may include emergency response, sports analysis, telemedicine, and other fields where adaptable real-time and recorded content are essential.

Traditional video conferencing and media management platforms lack advanced real-time interaction capabilities, limited to static media control and post-event analysis. The gap in functionality results in constrained decision-making for critical scenarios, such as emergency responses, where dynamic, context-sensitive tools are vital. Existing platforms may not provide multi-agent orchestration to handle real-time AI content integration and external data sources, simultaneous control over live video, historical recordings, AI-generated insights, user-specific, and adaptable media compositions that may combine live and recorded media streams in response to dynamic session needs.

The AI-driven real-time collaboration system is a unified collaboration platform that dynamically integrates multiple video, audio, and data streams. Further, the system may adapt based on a user role, situational need, and AI-driven insights. The methods and systems disclosed herein may support synchronized live interaction and AI-controlled media compositing while incorporating historical media files for asynchronous playback, delivering a comprehensive solution that enhances situational awareness. The methods and systems disclosed herein may use a protocol supporting real-time data and media streaming, asynchronous media playback, and tools for file-based video management. The present disclosure encompasses the following aspects:

### Dynamic Multi-Channel Media Orchestration:

The method and system disclosed herein may provide live and historical media streams, leveraging WebRTC or similar protocols for real-time interaction and NVStreamer (or equivalent) for file-based playback, all integrated with HLS/DASH (or equivalent) for asynchronous access and review.

### AI-Enhanced Content Orchestration and Adaptive Media Control:

The method and system disclosed herein may manage live and historical video streams, may allow dynamic activation, media switching, and PTZ camera adjustments in response to real-time events or AI-driven alerts.

### Multi-Agent System for Real-Time and Asynchronous Collaboration:

The method and system disclosed herein may integrate multiple AI agents to incorporate external data sources (e.g., maps, regulations, analytics) based on evolving session needs, enhancing user interaction through event-driven automation.
   User-Specific Interaction with Custom Players:
The method and system disclosed herein may enable users to tailor media views, allowing the users to control live and recorded content streams, interact with 3D models, and use maps or other contextual visualization tools. The content streams may consist of a real-world, an AI-generated, simulated, bi-directional interaction, or other type of media data, media overlay, and interaction mechanisms.

### Persistent State Synchronization and Metadata Handling:

The method and system disclosed herein may facilitate real-time synchronization of media control and state, ensuring seamless transitions and collaboration between live and recorded content, using SignalR or similar frameworks.

### Event-Driven Automation Via AI Agents:

The method and system disclosed herein may allow AI agents to activate streams, issue real-time alerts, or overlay metadata through generated overlays, content, and/or WebRTC data channels (or equivalent), adapting the content dynamically based on session requirements.

### Asynchronous Playback and AI-Generated Summaries:

The method and system disclosed herein may deliver recaps and multi-modal summaries via HLS/DASH/RTSP/RTMP/WebRTC (or equivalent) for users who missed sessions or need post-event analysis, incorporating AI-driven insights for enhanced context.

The following are detailed description of each aspect:

### Dynamic Multi-Channel Media Orchestration

The method and system disclosed herein may support real-time and historical media through WebRTC, NVStreamer, and HLS/DASH (or equivalent) may allow users to select and compose views that are relevant to their roles. Further, the disclosed system and method may also allow users to combine live feeds with archived footage, enabling them to focus on the most pertinent content.
Example: In a sports session, coaches may toggle between live multi-angle feeds and archived videos of past games. For emergency response, users may focus on active streams but access historical footage to evaluate incident patterns. The above system is based on real-time collaboration.

### AI-Enhanced Content Orchestration and Adaptive Media Control

The method and system disclosed herein comprises AI pipelines and/or agents. The AI agents may monitor and manage media streams, adjust content based on session dynamics. The AI-driven control of PTZ cameras and automated switching between live and historical feeds may enhance the adaptability of this platform.
Example: During a traffic incident, the method and system disclosed herein may switch between cameras, highlight relevant intersections, and include archived footage of similar incidents, providing comprehensive situational awareness.

### Multi-Agent System and Metadata Integration

The method and system disclosed herein may use multi-agent frameworks to bring in relevant external data into the session in real time. The external data may include geographic information, regulatory guidelines, or historical analytics. The agent or AI agent may assist by synthesizing contextual data, adjusting views, or offering annotations. The agent or AI agent may encompass AI pipelines and generative AI. For instance, computer vision pipelines for analyzing sports performance, and generative AI for generating additional commentary and/or visualizations based on data.
Example: During a sports session, the system may overlay historical performance data to aid analysis. In medical use cases, the method and system may provide relevant research articles or patient histories for reference.
   User-Specific Interaction with Custom Players

The method and system disclosed herein may enable participants to interact with multi-modal content, allowing the users to select individual streams, overlay 3D models, or manipulate maps. Custom players may add a layer of interactivity, adapting to the unique requirements of each user. The custom player is an application and/or a user interface that allows the user to engage with the solution, but may have customizations to facilitate a particular workflow/objective (e.g., shot analysis vs. emergency response). The method and system may include multi-modal input and output.
Example: A coach may replay a 3D skeleton overlay of a basketball player's shot, analyzing joint angles. A dispatcher may monitor live streams alongside map visualizations, tracking multiple incidents. The content stream may have an AI-enhanced video with body skeleton overlay, 3D visualization (where the basketball shooting is in 3D space and his shooting wrist relative to the hoop), and interactive 2D or 3D representations and/or models (coach pauses and clicks on the player's wrist and the last 10 3D shoots with similar shoot release come into the situation room for coaching).

### Persistent State Synchronization and Event Handling

The method and system disclosed herein may maintain state synchronization through SignalR (or similar frameworks), ensuring that all participants experience real-time updates across devices. Metadata is transmitted through data channels, ensuring smooth content adjustments and synchronized interaction.
Example: During a telemedicine session, patient models and diagnostics are updated in real time, providing consistent views across all devices and supporting effective collaboration.

### Asynchronous Playback and Multi-Modal Summarization

The method and system disclosed herein may provide asynchronous access to recorded sessions through HLS/DASH (or similar). The summaries generated by AI agents may capture key events, offering valuable insights for users who missed the live session or need a condensed overview.
Example: A sports analyst reviews a post-game summary, which may include AI-driven annotations and key moments. Emergency responders may catch up on prior events via recorded playback by integrating real-time and past incident details.

The methods and system disclosed herein may offer enhanced situational awareness for emergency response, sports analysis, and other high-stakes applications. Through scalable user-specific compositing and advanced interactivity, the system may create a responsive environment for timely, data-rich collaboration and decision-making. The methods and system disclosed herein may comprise Vision AI models to detect critical events in real time, dynamically adjusting content streams, and providing contextually relevant feedback to participants. The following key architectural features are disclosed in the present disclosure:

### Real-Time Vision AI and Multi-Track Video Streaming

Vision AI models, such as those based on Nvidia and DeepStream (or equivalent), may analyze video feeds in real-time, detect events like player movements in sports or emergency vehicle tracking. The above analysis may drive adaptive stream selection, ensuring participants view the most relevant feeds based on context, roles, or user preferences.
Multi-Track Support for Comprehensive Event Viewing: Using WebRTC, the platform may support synchronized video, audio, metadata, and control channels, delivering a layered view of unfolding events with real-time AI augmentation.
Flexible Composition of Historical and Live Content: Through NVStreamer (or similar tools), historical media files may be accessed, integrated with live feeds, or replayed as needed. The system may allow seamless transitions between real-time monitoring and in-depth analysis of archived footage, ensuring continuous situational awareness.
Example: In a sports training session, the platform may dynamically switch between live angles and historical footage based on detected movement patterns, providing athletes and coaches with both real-time insights and comparisons to past performances.

### Dynamic User-Specific Video and Audio Composition

Each user may tailor video views to their specific situational needs, whether for live incidents or archived review. Event-driven orchestration may enable each user session to generate custom composite views from selected camera feeds, layouts, and recorded media files.
Session Customization for Live and File-Based Media: Users may configure session-specific layouts that mix live feeds with playback of archived footage. The user-driven setup may create a responsive experience adaptable to diverse scenarios, like emergency response or interactive sports training.
Efficient Resource Management: Automated scaling provisions dedicate session instances as needed, while resource management systems may adjust dynamically based on session activity, ensuring the system efficiently supports high concurrency.
Example: During an emergency, a dispatcher may configure a view combining live intersection footage with historical recordings of prior incidents in the area, achieving a full perspective on situational risks and trends.

### AI-Controlled Stream Fusion and Contextual Management

The AI agents may manage and blend video feeds in real-time, selecting relevant content dynamically. For example, the system may activate additional cameras or historical data feeds based on live analysis, adjusting views to provide users with the most critical information as events evolve.
Example: In an emergency, if a camera view is obscured, the AI agents may automatically switch to a neighboring camera or adjust PTZ (pan-tilt-zoom) settings to maintain visibility. Concurrently, historical data relevant to the incident may be surfaced, aiding decision-making.

### Multi-Agent AI for Enhanced Situational Awareness

The multi-agent systems may retrieve and inject content (e.g., maps, regulations, or other contextual information) into the collaboration space, providing participants with synthesized insights that adapt to evolving scenarios. The above feature may extend the platform's capabilities by creating a seamless blend of live media, stored content, and auxiliary data relevant to the situation.

Example: In an emergency scenario, the system may pull up local traffic regulations or historical incident patterns, presenting the local traffic regulations or historical incident patterns alongside live video to provide real-time context for participants.

### Interactive, Multi-Channel Flexibility and Adaptive Playback

The platform may support interactivity through custom players that allow users to switch between real-time feeds, replay segments, or view synchronized multi-angle perspectives. Adaptive stream selection and user controls may allow participants to customize views for an optimal experience.
Example: A coach in a basketball session may focus solely on overhead views to analyze positioning, toggling other angles based on AI-generated feedback or replaying key segments for detailed review.

### Flexible Session Recording and Asynchronous Playback

Beyond live interaction, the platform may support HLS/DASH (or equivalent) streaming, enabling participants to review archived sessions asynchronously. Each session-specific composition, whether live, recorded, or mixed, is saved for later analysis, which may support in-depth review, training, or documentation.
Example: In sports training, multi-angle replays synchronized with AI-driven annotations offer coaches an interactive post-session review, helping identify trends or areas for improvement.

### Backend Architecture and Key Components

The platform may operate on a resilient micro services architecture, integrating real-time AI, multi-modal media management, and synchronized collaboration. Key components include:

Multi-Track WebRTC Support and Ant Media (or similar media server) Integration: Handles video, audio, and metadata channels, providing scalable multi-stream capabilities for diverse media types.

Persistent Synchronization and Metadata Management: Real-time synchronization, driven by SignalR, manages media playback, data flows, and control channels to keep participants aligned with updates and annotations.

Event-Driven Session and Data Orchestration: Using Redis for session state and Kafka for event-driven orchestration, the system dynamically adjusts to each user's unique needs, balancing resources across live and recorded media.

GPU-Accelerated AI Models for Content Analysis: Through DeepStream or similar technologies, real-time AI processes camera feeds, detecting critical events, and adjusting content delivery for optimal situational awareness.

Workflow-Driven Collaboration: The methods and system are tailored to orchestrate collaboration around specific missions or workflows (e.g., emergency responses or sports training) and dynamically integrating content to match the situational context. Beyond streaming, the platform may incorporate AI-driven enhancements (e.g., overlays, event summaries) to generate actionable insights and new content within a session.

AI-Enhanced Content Creation: Beyond streaming, the platform may incorporate AI-driven enhancements (e.g., overlays, event summaries) to generate actionable insights and new content within a session.

AI-Initiated Content Orchestration: AI plays a central role in dynamically activating streams, integrating external data sources, and tailoring content orchestration to evolving session needs, enabling real-time adaptation to mission-critical requirements.

User-Controlled Interaction: The methods and system may allow users to customize the user's experience by choosing perspectives, filtering streams, or interacting with AI-generated annotations. The system may provide a level of personalization and interactivity not typically seen.

The method and system may provide a collaborative environment that adapts dynamically to mission needs, integrates external data, and allows real-time and asynchronous user control by mission-centric orchestration.

The existing video streaming systems are associated with limitations by focusing only on video and audio data. The limitation includes limited interactivity between the viewers and the video. For instance, broadcasting of multiple camera events, the existing video streaming systems fail to seamlessly synchronize the multiple streams. The lack of synchronization reduces the interactivity, particularly for applications that require real-time synchronization.

The present disclosure relates to an innovative enhancement in sports video analytics and playback capabilities, offering a revolutionary approach to broadcasting. The system's solution may introduce advanced metadata encoding and seamless multi-camera synchronization. The present disclosure pertains to the fields of metadata-driven playback systems and enhanced broadcasting technology.

The system's 6D Encoding for Broadcasting Enhancements:

The encoding component revolutionizes video enrichment for both file-based and streaming workflows by embedding supplemental metadata:
1. The system's 6D Encoding: The method and system enhance video streams with supplemental metadata structures that embed:
   Event-based metadata
   Pose data and phase markers
   Global metadata for session configurations and player initialization.
   The event-based metadata includes activity markers, phase transitions, motion cues, or other contextual signals representing the characteristics of a recorded event. The supplemental metadata structures include Supplemental Enhancement Information (SEI) or other embedded metadata formats (e.g., SMPTE 336M KLV, MPEG-7, or user-defined metadata containers).
2. Invisible Enhancements for Universal Access: The system's encoding ensures compatibility with multimedia playback environments while unlocking advanced playback features in the system's 6D Player. The multimedia playback environment includes standalone media players, web-based media players, smart TV applications, augmented reality (AR) or virtual reality (VR) display systems, and cloud-based video processing frameworks.
3. Rich Metadata for Real-Time Interactivity:
   Frame-specific pose key points and activity classifications.
   Session-level configuration metadata is embedded periodically for synchronization.
4. Multi-Stream Synchronization: Enable seamless switching between multi-camera views and synchronized playback for an immersive experience.

The method and system are associated with the following architecture and methodology:

The system's 6D Encoding Workflow:
1. Input Video Sources: The method and system accept standard video inputs (container formats, real-time media transport protocols, etc.). The real-time media transport protocols include, but are not limited to, RTSP, WebRTC, SRT, RTP, or similar real-time streaming formats. The container formats, such as MP4, MKV, WebM, TS, or other multimedia container formats, support metadata embedding.
2. AI-Powered Analysis:
   Pose Estimation: The method and system include key point-based or skeletal motion analysis techniques, including but not limited to pose landmark detection, action recognition, motion tracking, and 3D kinematic modeling. The pose estimation models include, but are not limited to, a BlazePose, OpenPose, MediaPipe Pose, AlphaPose, or a custom-trained key point detection network.
   Activity Detection: The method and system identify and label key phases (e.g., pocket, release).
3. Metadata Embedding:
   The method and system embed SEI-based metadata in a video compression standard, including but not limited to H.264, H.265, AV1, VVC (H.266), or any similar encoding format.
   The method and system maintain lightweight metadata payloads for efficient delivery.
4. Output Enhanced Streams:
   Produce universally compatible videos enriched with the system's metadata.

### Use Cases and Value Proposition for Broadcasters:

Enrich live sports coverage with event-based metadata and 3D/6D visualizations.
Offer a differentiated viewer experience with subscription-based premium features.

The present disclosure encompasses the following key aspect:
A system for embedding metadata into video streams to enable enhanced playback, including activity markers, pose data, and phase labels.

In some embodiments, the disclosed system and method may inherently improve the field of real-time media stream processing and orchestration by addressing the technical problem of rigid, rule-based stream control that fails under dynamically evolving collaborative contexts. In some embodiments, the system may include a context-adaptive orchestration engine that may perform continuous multi-dimensional inference over media stream data and collaboration context data using temporally aligned latent representations.

In some embodiments, such latent representations may be generated using transformer-based sequence models, spatio-temporal graph neural networks, or hybrid attention mechanisms that jointly encode visual, temporal, and interaction signals. In some embodiments, the above feature may improve the technology of AI-driven media orchestration by enabling sub-second reconfiguration of stream parameters, such as camera focus, bitrate allocation, and stream prioritization, based on inferred collaborative intent rather than predefined triggers.

In some embodiments, the technical improvement may be realized through implementation variants including server-side inference pipelines, edge-deployed lightweight inference models, or federated inference architectures where partial context embeddings are generated on client devices and aggregated at an orchestration server.

In some embodiments, the system may inherently improve multimedia synchronization technology by solving the technical problem of temporal drift and semantic misalignment across heterogeneous media sources. In some embodiments, the invention may include a semantic timebase alignment mechanism that may perform cross-stream synchronization not solely based on timestamps but also based on detected semantic events, such as motion patterns, phase transitions, or detected interaction cues.

In some embodiments, the semantic timebase alignment mechanism may be implemented using dynamic time warping over feature embeddings, contrastive representation alignment, or probabilistic temporal graphs that align streams based on the likelihood of semantic correspondence. In some embodiments, the system may improve the technology of multi-camera and multi-source video synchronization by enabling resilient alignment even when clock drift, packet loss, or variable latency is present.

In some embodiments, the system may inherently improve metadata embedding and transport technology by addressing the technical problem of metadata fragility and incompatibility with standard playback pipelines. In some embodiments, the system may include a self-describing supplemental metadata container that may be embedded invisibly within video frames or associated transport layers while remaining compliant with existing multimedia standards. In some embodiments, the self-describing supplemental metadata container may include adaptive schemas, versioned descriptors, and forward-compatible decoding hints that allow playback systems to safely ignore or partially interpret metadata without failure.

In some embodiments, the self-describing supplemental metadata container feature may be implemented using SEI message extensions, timed metadata tracks, or container-level sidecar streams that are dynamically merged during playback. In some embodiments, the system may improve the technology of enhanced video playback by enabling advanced interactivity without disrupting legacy playback environments.

In some embodiments, the system may inherently improve automated camera control technology by addressing the technical problem of oscillatory or unstable camera behavior in AI-controlled systems. In some embodiments, the system may include a predictive camera control model that may perform short-horizon forecasting of subject motion and interaction likelihood, thereby stabilizing camera transitions and reducing jitter. In some embodiments, such forecasting may be implemented using recurrent neural networks, diffusion-based motion predictors, or Bayesian state estimators that integrate uncertainty estimates. In some embodiments, the system may improve the technology of autonomous camera systems by enabling smoother, context-aware framing decisions that are anticipatory rather than reactive.

In some embodiments, the system may inherently improve session summarization technology by addressing the technical problem of lossy post-hoc summarization that ignores orchestration decisions made during live sessions. In some embodiments, the system may include a provenance-aware session summarization pipeline that may generate summaries by tracing orchestration decisions, event indicators, and stream priority changes over time. In some embodiments, the provenance-aware session summarization pipeline may be implemented using causal graphs, decision logs, or attention attribution maps derived from orchestration models. In some embodiments, the system may improve the technology of automated media summarization by producing summaries that preserve narrative coherence and contextual relevance.

In some embodiments, the system may further include additional technical improvements that may be optionally incorporated to extend functionality. In some embodiments, the system may include a privacy-preserving collaboration context analysis module that may address the technical problem of exposing sensitive user interaction data during orchestration. In some embodiments, the privacy-preserving collaboration context analysis module may implement techniques such as homomorphic encryption, secure enclaves, or split learning, where sensitive context features are processed locally while only anonymized embeddings are transmitted. In some embodiments, the system may improve the technology of secure collaborative media systems.

In some embodiments, the system may include an adaptive bitrate intelligence layer that may address the technical problem of inefficient bandwidth utilization during multi-stream orchestration. In some embodiments, the adaptive bitrate intelligence layer may use reinforcement learning or multi-armed bandit algorithms to dynamically allocate bitrate budgets across streams based on predicted user attention and event likelihood. In some embodiments, the system may improve the technology of adaptive streaming by optimizing perceptual quality under constrained network conditions.

In some embodiments, the system may include a cross-session orchestration learning mechanism that may address the technical problem of isolated session optimization. In some embodiments, the cross-session orchestration learning mechanism may aggregate orchestration outcomes across sessions to train meta-models that improve future orchestration strategies. In some embodiments, the system may be implemented using continual learning frameworks, experience replay buffers, or policy distillation techniques. In some embodiments, the system may improve the technology of AI-driven media orchestration by enabling long-term performance optimization.

In some embodiments, the system may include a real-time explainability interface that may address the technical problem of opaque AI-driven orchestration decisions. In some embodiments, the real-time explainability interface may generate machine-readable and human-interpretable explanations derived from attention weights, feature attributions, or decision rules extracted from orchestration models. In some embodiments, the system may improve the technology of human-AI collaboration by enabling operators to understand, audit, and adjust orchestration behavior.

In some embodiments, the system may include an adaptive replay synthesis engine that may address the technical problem of static replay generation. In some embodiments, the adaptive replay synthesis engine may generate multiple replay variants tailored to different viewer roles or analytical objectives by reusing orchestrated media data and embedded metadata. In some embodiments, the adaptive replay synthesis engine may be implemented using rule-based replay templates, learned replay policies, or viewer-driven parameter selection. In some embodiments, the adaptive replay synthesis engine may improve the technology of media replay and post-event analysis.

Collectively, the above embodiments may enable a technically advanced, flexible, and extensible media orchestration framework that improves multiple underlying technologies, including real-time media processing, AI-driven orchestration, metadata-enhanced playback, and collaborative broadcasting systems, while remaining compatible with existing infrastructure and standards.

Further, the present disclosure describes a method of facilitating AI-driven real-time collaborative media orchestration. Further, the method may include receiving, using a communication device, a media stream data from a media source system over a communication network. Further, the method may include receiving, using the communication device, a collaboration context data from a client device over the communication network. Further, the method may include analyzing, using a processing device, the media stream data based on the collaboration context data. Further, the method may include determining, using the processing device, an adaptive orchestration data representing a dynamic control of the media stream data. Further, the method may include generating, using the processing device, an orchestrated media data based on the adaptive orchestration data. Further, the method may include storing, using a storage device, the orchestrated media data. Further, the method may include transmitting, using the communication device, the orchestrated media data to the client device.

In some embodiments, the analyzing the media stream data may include identifying an event indicator in the media stream data. Further, the analyzing of the media stream data may include selecting a stream priority parameter for the media stream data based on the event indicator.

In some embodiments, the method further may include receiving, using the communication device, an external reference data from an external data source system over the communication network. Further, in some embodiments, the method may further include storing, using the storage device, the external reference data.

In some embodiments, the method may include determining, using the processing device, a session state data representing a session state associated with the orchestrated media data. Further, the transmitting of the orchestrated media data may include transmitting the session state data to the client device.

In some embodiments, the method further may include generating, using the processing device, a replay media data based on the orchestrated media data. Further, in some embodiments, the method further may include storing, using the storage device, the replay media data.

In some embodiments, the receiving of the collaboration context data may include receiving a stream selection data from the client device over the communication network. Further, the method further may include storing, using the storage device, the stream selection data.

In some embodiments, the determining of the adaptive orchestration data may include determining a camera control data based on the media stream data. Further, the method further may include storing, using the storage device, the camera control data.

In some embodiments, the receiving of the media stream data may include receiving a metadata associated with the media stream data from the media source system over the communication network. Further, the method further may include storing, using the storage device, the metadata.

In some embodiments, the method further may include receiving, using the communication device, a visualization data from an external data source system over the communication network. Further, in some embodiments, the method further may include generating, using the processing device, an overlay data based on the visualization data.

In some embodiments, the method further may include generating, using the processing device, a session summary data based on the orchestrated media data. Further, in some embodiments, the method further may include transmitting, using the communication device, the session summary data to the client device.

The present disclosure provides a system for facilitating AI-driven real-time collaborative media orchestration. Further, the system may include a communication device. Further, the communication device may be configured for receiving a media stream data from a media source system over a communication network. Further, the communication device may be configured for receiving a collaboration context data from a client device over the communication network. Further, the communication device may be configured for transmitting an orchestrated media data to the client device. Further, the system may include a processing device communicatively coupled with the communication device. Further, the processing device may be configured for analyzing the media stream data based on the collaboration context data. Further, the processing device may be configured for determining an adaptive orchestration data representing a dynamic control of the media stream data. Further, the processing device may be configured for generating the orchestrated media data based on the adaptive orchestration data. Further, the system may include a storage device communicatively coupled with the processing device. Further, the storage device may be configured for storing the orchestrated media data.

Further, in some embodiments, the processing device may be further configured for identifying an event indicator in the media stream data. Further, the processing device may be further configured for selecting a stream priority parameter for the media stream data based on the event indicator.

In some embodiments, the communication device may be further configured for receiving an external reference data from an external data source system over the communication network. Further, the storage device may be further configured for storing the external reference data.

In some embodiments, the processing device may be further configured for determining a session state data representing a session state associated with the orchestrated media data. Further, the communication device may be further configured for transmitting the session state data to the client device.

In some embodiments, the processing device may be further configured for generating a replay media data based on the orchestrated media data. Further, the storage device may be further configured for storing the replay media data.

In some embodiments, the communication device may be further configured for receiving a stream selection data from the client device over the communication network. Further, the storage device may be further configured for storing the stream selection data.

In some embodiments, the processing device may be further configured for determining a camera control data based on the media stream data. Further, the storage device may be further configured for storing the camera control data.

In some embodiments, the communication device may be further configured for receiving a metadata associated with the media stream data from the media source system over the communication network. Further, the storage device may be further configured for storing the metadata.

In some embodiments, the communication device may be further configured for receiving a visualization data from an external data source system over the communication network. Further, the processing device may be further configured for generating an overlay data based on the visualization data.

In some embodiments, the processing device may be further configured for generating a session summary data based on the orchestrated media data. Further, the communication device may be further configured for transmitting the session summary data to the client device.

The present disclosure provides a method of facilitating metadata-driven enhanced video playback for broadcasting. Further, the method may include receiving, using a communication device, a video data from a video source system over a communication network. Further, the method may include receiving, using the communication device, an analysis metadata from an analytics system over the communication network. Further, the method may include processing, using a processing device, the video data to associate the analysis metadata with a frame of the video data. Further, the method may include generating, using the processing device, an enhanced video data by embedding the analysis metadata into the video data as a supplemental metadata structure. Further, the method may include storing, using a storage device, the enhanced video data. Further, the method may include transmitting, using the communication device, the enhanced video data to a client system over the communication network.

In some embodiments, the generating of the enhanced video data further may include processing the analysis metadata to include a frame-level event marker associated with a frame of the video data.

In some embodiments, the generating of the enhanced video data further may include processing the analysis metadata to include a pose key point associated with a frame of the video data.

In some embodiments, the generating of the enhanced video data further may include processing the analysis metadata to include a phase transition label associated with an activity represented in the video data.

In some embodiments, the generating of the enhanced video data further may include processing the analysis metadata to include a session configuration data embedded periodically within the video data.

In some embodiments, the generating of the enhanced video data further may include processing the analysis metadata to include a temporal synchronization data enabling alignment of a camera view with another camera view.

In some embodiments, the generating of the enhanced video data further may include processing the analysis metadata as an invisible metadata structure that preserves compatibility with a standard multimedia playback environment.

In some embodiments, the generating of the enhanced video data further may include processing the analysis metadata as a lightweight payload which may be configured to reduce transmission overhead.

In some embodiments, the generating of the enhanced video data further may include processing the analysis metadata in a standard-compliant supplemental metadata format.

In some embodiments, the transmitting of the enhanced video data further may include transmitting the enhanced video data which may be configured to enable interactive playback based on the embedded analysis metadata.

The present disclosure provides a system for facilitating metadata-driven enhanced video playback for broadcasting. Further, the system may include a communication device. Further, the communication device may be configured for receiving a video data from a video source system over a communication network. Further, the communication device may be configured for receiving an analysis metadata from an analytics system over the communication network. Further, the communication device may be configured for transmitting an enhanced video data to a client system over the communication network. Further, the system may include a processing device communicatively coupled with the communication device. Further, the processing device may be configured for processing the video data to associate the analysis metadata with a frame of the video data. Further, the processing device may be configured for generating the enhanced video data by embedding the analysis metadata into the video data as a supplemental metadata structure. Further, the system may include a storage device. Further, the storage device communicatively coupled with the processing device may be configured for storing the enhanced video data.

In some embodiments, the processing device may be further configured for processing the analysis metadata to include a frame-level event marker associated with a frame of the video data.

In some embodiments, the processing device may be further configured for processing the analysis metadata to include a pose key point associated with a frame of the video data.

In some embodiments, the processing device may be further configured for processing the analysis metadata to include a phase transition label associated with an activity represented in the video data.

In some embodiments, the processing device may be further configured for processing the analysis metadata to include a session configuration data embedded periodically within the video data.

In some embodiments, the processing device may be further configured for processing the analysis metadata to include a temporal synchronization data enabling alignment of a camera view with another camera view.

In some embodiments, the processing device may be further configured for processing the analysis metadata as an invisible metadata structure that preserves compatibility with a standard multimedia playback environment.

In some embodiments, the processing device may be further configured for processing the analysis metadata as a lightweight payload which may be configured to reduce transmission overhead.

In some embodiments, the processing device may be further configured for processing the analysis metadata in a standard-compliant supplemental metadata format.

In some embodiments, the communication device may be further configured for transmitting the enhanced video data which may be configured to enable interactive playback based on the embedded analysis metadata.

Further, the present disclosure describes a method of provisioning digital content. Further, the method may include monitoring, using the communication device, channel characteristics of a communication channel used for communicating with the at least one user device. Further, the monitoring may be performed continuously or periodically at a monitoring cadence (e.g., every 50 ms-5 s), and may include collecting network and transport telemetry from at least one of: (i) acknowledgement events, (ii) receiver feedback reports, (iii) congestion signals, and/or (iv) packet arrival timing data.

Further, in some embodiments, the channel characteristics may include, for example, round-trip time (RTT), jitter, packet loss rate, retransmission rate, congestion indication, acknowledged receive rate, or other communication-channel metrics that characterize delivery conditions for streaming segments. Further, RTT may be determined based on acknowledgement timing (e.g., difference between a packet send timestamp and a corresponding acknowledgement receipt timestamp). Further, packet loss rate may be determined based on missing sequence numbers, negative acknowledgements, or receiver reports indicating lost packets. Further, jitter may be determined based on variation in inter-arrival times for packets or frames, including computing an inter-arrival jitter statistic over the measurement interval.

Further, in some embodiments, the method may include determining, based on the monitoring, user device parameters comprising at least an effective throughput parameter and a playback buffer parameter. Further, the effective throughput parameter may be computed using successfully delivered bytes over a measurement interval and timing information. For example, the effective throughput parameter may be computed as:

$$Throughput = ( AckedBytes \times 8 ) / IntervalDuration ,$$

where AckedBytes is a number of media payload bytes acknowledged or otherwise confirmed delivered during the measurement interval, and IntervalDuration is the duration of the measurement interval in seconds.

Further, in some embodiments, the effective throughput parameter may be adjusted based on loss or congestion, such as by applying a penalty factor determined from packet loss rate, ECN markings, or retransmission rate.

Further, in some embodiments, the playback buffer parameter may be determined using buffer-level reports received from the at least one user device and/or observed segment download timing associated with the at least one user device. For example, the at least one user device may periodically send buffer occupancy reports including playable seconds available or buffered segment identifiers. Additionally or alternatively, the processing device may infer buffer occupancy based on (i) segment download completion times, (ii) segment decode/playout rate, and (iii) segment duration, such that buffer occupancy time is estimated as a difference between total playable duration downloaded and elapsed playout time.

Further, in some embodiments, the method may maintain per-user session state in memory including at least: (i) a current throughput estimate, (ii) a current buffer occupancy estimate, (iii) an RTT statistic, and (iv) a loss/jitter statistic, and may update the per-user session state at each monitoring cadence.

Further, in some embodiments, the method may include initializing and configuring, using the processing device, a generative machine learning model using at least the channel characteristics and the user device parameters as input features. Further, initializing may include loading model weights from non-volatile storage into memory and configuring an inference graph for execution on at least one of a CPU (central processing unit), GPU (graphics processing unit), or NPU (neural processing unit) comprised in the processing device. Further, the configuring may include selecting a feature set, feature scaling, and an inference cadence aligned to a segment boundary schedule.

Further, in some embodiments, the input features may include at least: (i) effective throughput parameter, (ii) playback buffer parameter, (iii) RTT, (iv) jitter, (v) loss rate, and optionally (vi) recent segment download times, (vii) recent representation changes, and (viii) an encoder processing latency value for the processing device. Further, the input features may be aggregated as a time series over a sliding window (e.g., last 1-30 seconds), thereby enabling the generative machine learning model to learn temporal channel dynamics.

Further, in some embodiments, the generative machine learning model may be implemented as a sequence model configured to accept the time series features and output the segment synthesis specification. For example, the generative machine learning model may include one or more recurrent layers, temporal convolution layers, transformer layers, or other sequence-processing layers configured to produce outputs for at least one upcoming segment interval.

Further, in some embodiments, the generative machine learning model may output the segment synthesis specification identifying the required segment duration and the required resolution. Further, the segment synthesis specification may further include one or more of: a predicted bandwidth distribution, a predicted buffer occupancy trajectory, a confidence value, a target frame rate, a target bitrate, and/or a keyframe placement instruction for the next segment.

Further, in some embodiments, the generative machine learning model is configured to preemptively produce, from a single instance of the at least one content stream data, a next segment of the adaptive content stream data having a required segment duration and a required resolution for transmission to the at least one user device. Further, the required segment duration and the required resolution may be selected to reduce at least one technical problem including playback stalls, rebuffering, end-to-end latency, or oscillatory switching between representations.

Further, in some embodiments, the processing device may generate the next segment based on the segment synthesis specification by performing one or more synthesis operations. Further, the synthesis operations may include temporal synthesis to satisfy the required segment duration and/or spatial synthesis to satisfy the required resolution.

Further, in some embodiments, temporal synthesis may include at least one of:
1. frame dropping, in which the processing device removes one or more frames from a decoded frame sequence to reduce a segment duration or to meet a target output frame rate;
2. frame duplication, in which the processing device duplicates one or more frames to increase a segment duration; and/or
3. frame interpolation, in which the processing device generates one or more intermediate frames between two frames using motion estimation, optical flow, or a learned interpolation network to increase temporal density while meeting a target duration.

Further, in some embodiments, spatial synthesis may include at least one of:
1. downscaling, in which the processing device reduces frame dimensions using a resampling filter; and/or
2. super-resolution processing, in which the processing device applies a learned upscaling model and/or multi-frame reconstruction to generate frames at the required resolution.

Further, in some embodiments, preemptively producing the next segment may include: (i) decoding a portion of the single instance of the at least one content stream data into decoded frames, (ii) applying temporal synthesis and/or spatial synthesis to obtain synthesized frames conforming to the segment synthesis specification, (iii) encoding the synthesized frames into an encoded segment using a selected codec, and (iv) packaging the encoded segment in accordance with the adaptive bitrate streaming protocol.

Further, in some embodiments, segment boundaries may be aligned to a segment schedule associated with the adaptive bitrate streaming protocol, such that a segment start time and end time correspond to manifest-advertised boundaries. Further, in some embodiments, the processing device may ensure decodability by placing a keyframe at a segment boundary or selecting a segment boundary at a keyframe.

Further, in some embodiments, the preemptively producing of the next segment may be performed prior to receiving a request for the next segment from the at least one user device, such that a segment satisfying the required segment duration and required resolution is available for transmission with reduced delay. Further, the processing device may execute inference for the generative machine learning model at an inference time that precedes the expected segment request time by a prefetch lead time (e.g., 50 ms-2 s), thereby compensating for encoding and packaging latency.

Further, the required segment duration and the required resolution may be determined subject to one or more operational constraints such as a maximum end-to-end latency constraint and a minimum playback buffer occupancy constraint. Further, the maximum end-to-end latency constraint may specify an upper bound on a time difference between a content source timestamp and a user-device playout timestamp (e.g., ≤1 s, ≤3 s, ≤10 s). Further, the minimum playback buffer occupancy constraint may specify that the playback buffer parameter should remain above a threshold (e.g., ≥0.5 s, ≥2 s, ≥5 s) to reduce playback stalls.

Further, in some embodiments, the processing device may validate the segment synthesis specification against the operational constraints and, upon determining that the segment synthesis specification violates the operational constraints, the processing device may modify the required segment duration and/or required resolution according to a constraint-handling rule (e.g., reduce resolution, reduce duration, or both) to restore compliance.

Further, in some embodiments, the generative machine learning model may dynamically adjust one or more model parameters responsible for producing the next segment based on the channel characteristics and the user device parameters. Further, the one or more model parameters may include, for example:
a generation confidence threshold specifying a minimum confidence required to accept a generated segment synthesis specification;
a synthesis strength parameter controlling an intensity of interpolation or super-resolution operations;
a temporal interpolation rate specifying a number of interpolated frames per second or a ratio of interpolated frames;
a spatial scaling factor specifying a target scaling ratio or output resolution class; and/or
feature weights applied to throughput and buffer occupancy to bias outputs toward stability or toward higher quality.

Further, in some embodiments, the processing device may compute a confidence value associated with the segment synthesis specification and may select between (i) using the segment synthesis specification or (ii) using a fallback synthesis specification generated according to a deterministic rule based on throughput and buffer occupancy. Further, such fallback behavior may improve operational robustness in cases of sparse telemetry, initialization phases, or transient channel instability.

Further, in some embodiments, the operations described herein may be implemented using one or more software components stored in memory and executed by the processing device, including a channel monitoring component, a throughput estimation component, a buffer estimation component, a model inference component, and a segment synthesis component. Further, each such component may correspond to executable instructions and associated data structures that perform the respective algorithms described above (e.g., computing throughput from acknowledged bytes, computing buffer occupancy from reports and/or timing, executing inference to produce a segment synthesis specification, and performing temporal/spatial synthesis operations). Further, the term “component” as used herein does not require any specific programming language or partitioning and is intended to cover implementations in software, firmware, hardware logic, or combinations thereof.

Further, in some embodiments, “channel characteristics” refer to measurable network/transport properties for a communication channel between the communication device and the at least one user device. Further, channel characteristics may be derived from transport feedback, packet timing observations, acknowledgement events, receiver reports, or link statistics.

Further, in some embodiments, an “effective throughput parameter” refers to a computed estimate of an application-usable delivery rate for media payloads, and may be expressed in bits per second (bps). Further, the effective throughput parameter may be computed over a measurement interval (e.g., 100 ms-10 s) and may incorporate one or more timing and loss factors.

Further, in some embodiments, a “playback buffer parameter” refers to a computed value indicating buffered playable media at the at least one user device, and may be expressed as buffer occupancy time (e.g., seconds of playable media) and/or buffer level in bytes/frames.

Further, in some embodiments, a “single instance of the at least one content stream data” refers to receiving one content stream (e.g., a single live input feed or a single encoded mezzanine stream) and producing one or more output segments/representations therefrom without requiring multiple separately sourced input streams for each output resolution/duration.

Further, in some embodiments, a “segment synthesis specification” refers to a data structure generated by the generative machine learning model that includes at least (i) a target segment start time, (ii) a target segment duration, (iii) a target resolution, and optionally (iv) a target frame rate, bitrate, codec profile, keyframe placement instruction, and/or an estimated confidence value.

Further, in some embodiments, “required segment duration” may correspond to a target segment length used by an adaptive bitrate streaming protocol (e.g., 0.25 s-10 s, including 0.5-6 s), and “required resolution” may correspond to a target spatial resolution (e.g., 426×240, 854×480, 1280×720, 1920×1080, 3840×2160, or other resolutions).

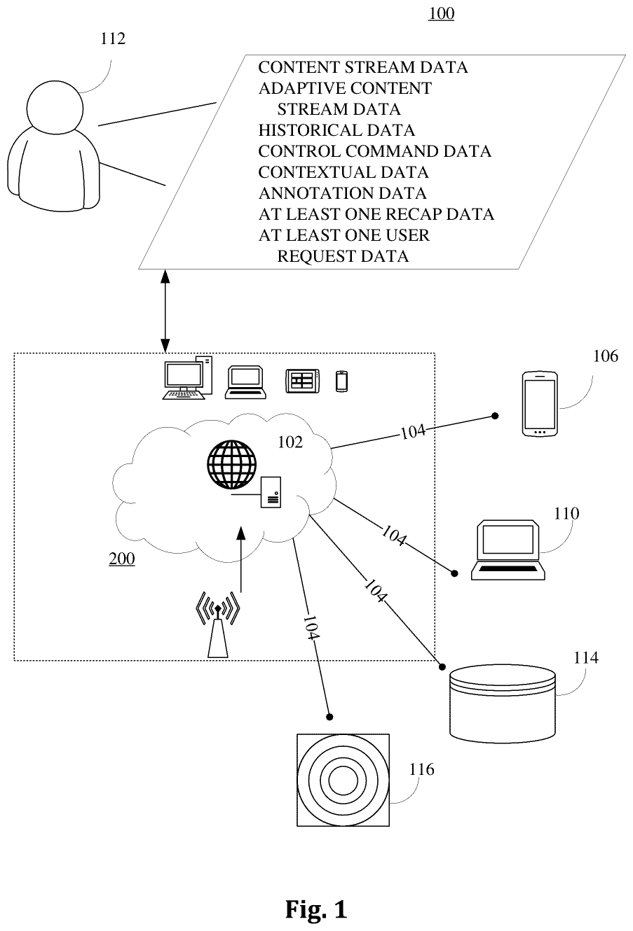

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

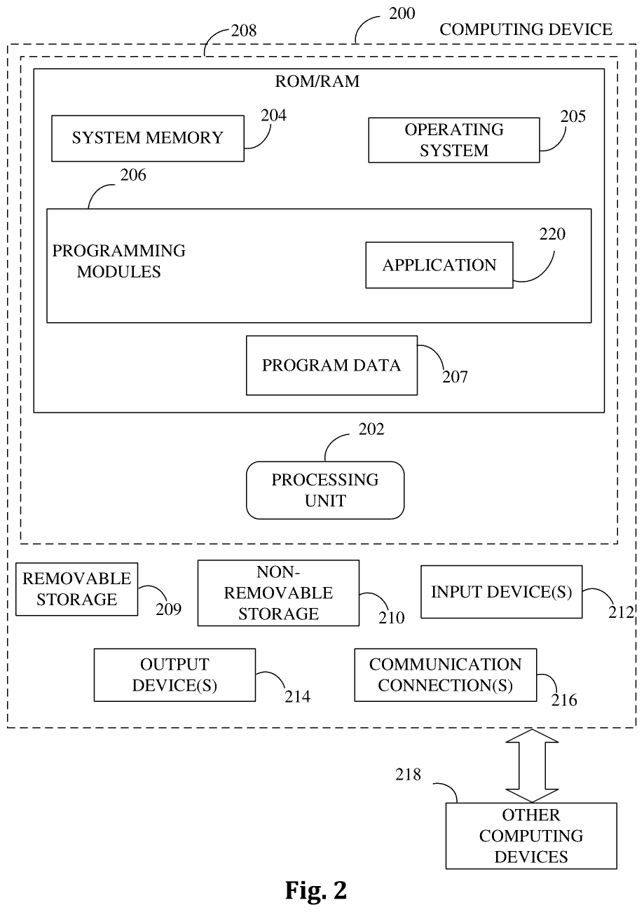

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

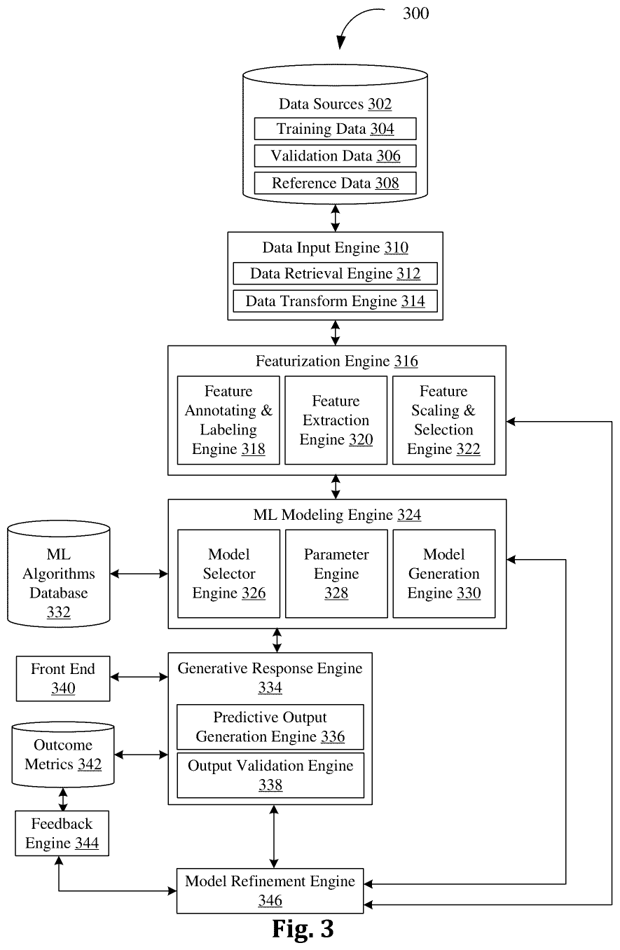

FIG. 3 is a block diagram illustrating a machine-learning system 300 for implementing various embodiments of this disclosure, in accordance with some embodiments. Although the disclosed machine-learning system 300 depicts particular system components and an arrangement of such components, the given depiction is to facilitate a discussion of the present technology and should not be considered limiting unless specified in the appended claims. For example, some components that are illustrated as separate, may be combined with other components, and some components may be divided into separate components.

Accordingly, the machine-learning system 300 may include a plurality of interrelated modules and engines configured to implement a machine-learning pipeline. Further, the machine-learning system 300 may include a data sources module 302 that is made up of a training data repository 304, a validation data repository 306, and a reference data repository 308, each repository being configured to store respective classes of input records and reference information. Further, the machine-learning system 300 may include a data input engine 310 configured to receive data from the data sources module 302. Further, the data input engine 310 may include a data retrieval engine 312 configured to access and ingest data from the repositories (304, 306, 308), and a data transform engine 314 configured to perform initial normalization, parsing and format conversion on the ingested data. Further, the machine-learning system 300 may include a featurization engine 316 configured to prepare temporal and predictive representations of transformed data. Further, the featurization engine 316 may include a feature annotating & labeling engine 318 for applying labels and annotations to data instances, a feature extraction engine 320 for deriving feature vectors and candidate predictors, and a feature scaling & selection engine 322 for performing numerical scaling, dimensionality reduction and selection of salient features. Further, the machine-learning system 300 may include a machine learning (ML) modeling engine 324 configured to construct predictive models from selected features. Further, the ML modeling engine 324 may include a model selector engine 326 for selecting among candidate model classes, a parameter engine 328 for determining and tuning hyperparameters, and a model generation engine 330 for instantiating and training model artifacts according to selected architectures and parameters. Further, the machine-learning system 300 may include an ML algorithms database 332 configured to store algorithmic implementations, model templates and associated metadata and to be accessible by components of the ML modeling engine 324. Further, the machine-learning system 300 may include a generative response engine 334 configured to produce user-facing outputs based on the trained models. Further, the generative response engine 334 may include a predictive output generation engine 336 for generating predictions or synthesized responses and an output validation engine 338 for verifying, filtering and validating generated outputs against predefined criteria and reference data. Further, the machine-learning system 300 may include a front end 340 configured to present validated outputs to end users and to collect interaction signals. Further, the machine-learning system 300 may include an outcome metrics module 342 configured to compute performance measures, accuracy statistics and other evaluation metrics derived from model outputs and user interactions. Further, the machine-learning system 300 may include a feedback engine 344 configured to aggregate outcome metrics and user feedback and to format such information for reuse. Further, the machine-learning system 300 may include a model refinement engine 346 configured to receive feedback from the feedback engine 344 and the outcome metrics module 342, and to effect iterative updates to the ML modeling engine 324 and to the ML algorithms database 332. Further, the components are communicatively coupled so that data and control signals are exchanged among the repositories (304, 306, 308), the data input engine 310, the featurization engine 316, the ML modeling engine 324 (with algorithmic support from the ML algorithms database 332), the generative response engine 334 and the front end 340 for output generation. Further, the outcome metrics 342 and feedback engine 344 provide closed-loop signals to the model refinement engine 346 to enable retraining, parameter adjustment and algorithm selection, thereby enabling cooperative execution of data acquisition, feature engineering, model construction, output generation, validation, evaluation and iterative refinement within the disclosed machine-learning system 300.

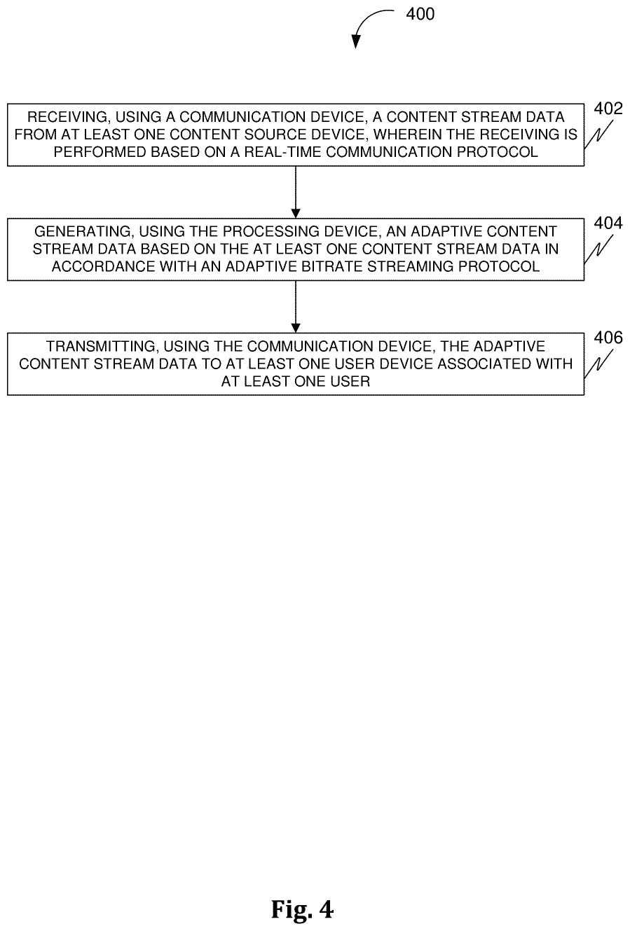

FIG. 4 illustrates a flowchart of a method 400 of provisioning digital content, in accordance with some embodiments. Further, the method 400 may include a step 402 of receiving, using a communication device 1202, a content stream data from one or more content source devices 1206. Further, the receiving may be performed based on a real-time communication protocol. Further, the method 400 may include a step 404 of generating, using the processing device 1204, an adaptive content stream data based on the one or more content stream data in accordance with an adaptive bitrate streaming protocol. Further, the method 400 may include a step 406 of transmitting, using the communication device 1202, the adaptive content stream data to one or more user devices 1208 associated with one or more users.

In some embodiments, the one or more content source devices 1206 include one or more sensor devices. Further, the one or more sensor devices may be configured for generating one or more sensor data representing one or more variables associated with an environment associated with the one or more content source devices 1206. Further, the one or more content source devices 1206 include the one or more sensor data. In some embodiments, the one or more user devices 1208 may be configured for presenting one or more Graphical User Interfaces. Further, the one or more Graphical User Interfaces may be configured to facilitate an interaction of the one or more users with the adaptive content stream data. Further, the method 400 further includes generating, using the processing device 1204, one or more user preference data based on the interaction of the one or more users with the adaptive content stream data. Further, the generating of the adaptive content stream data may be further based on the one or more user preference data.

In some embodiments, the one or more user preference data comprises one or more user interaction data indicating the interaction of the one or more users with the adaptive content stream data. Further, the method 400 further may include transmitting, using the communication device 1202, one or more interaction data to one or more other user devices. Further, the one or more other user devices and the one or more user devices 1208 may be associated with a session.

In some embodiments, the method 400 may further include retrieving, using a storage device 1302, a historical data based on the one or more user preference data. Further, in some embodiments, the method 400 further may include transmitting, using the communication device 1202, the historical data to the one or more user devices 1208.

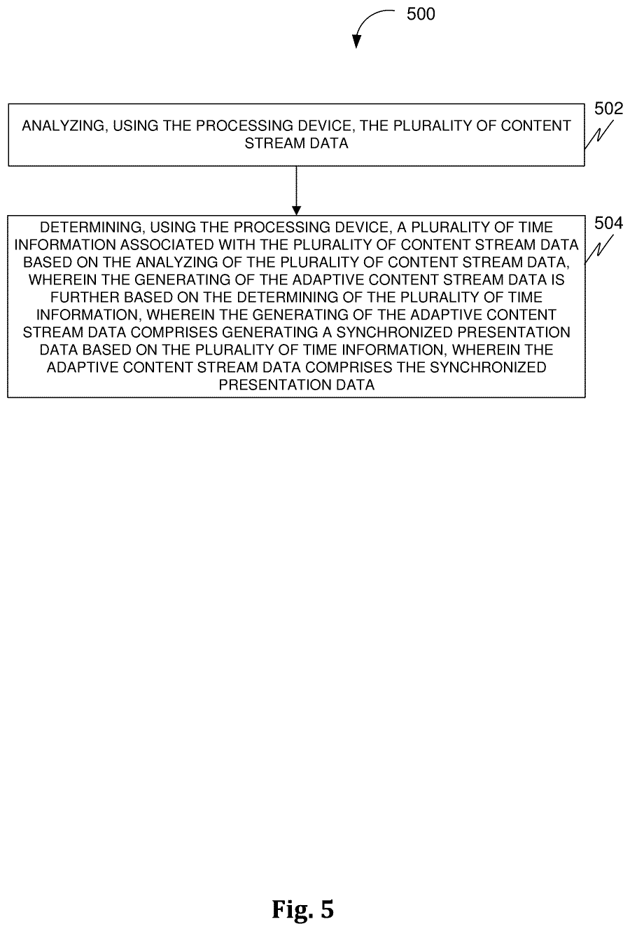

FIG. 5 illustrates a flowchart of a method 500 of provisioning digital content including determining, using the processing device 1204, a plurality of time information, in accordance with some embodiments. Further, in some embodiments, the receiving of the content stream data may include receiving two or more content stream data from two or more content source devices. Further, the method 500 may include a step 502 of analyzing, using the processing device 1204, the two or more content stream data. Further, the method 500 may include a step 504 of determining, using the processing device 1204, two or more time information associated with the two or more content stream data based on the analyzing of the two or more content stream data. Further, the generating of the adaptive content stream data may be further based on the determining of the two or more time information. Further, the generating of the adaptive content stream data includes generating a synchronized presentation data based on the two or more time information. Further, the adaptive content stream data includes the synchronized presentation data.

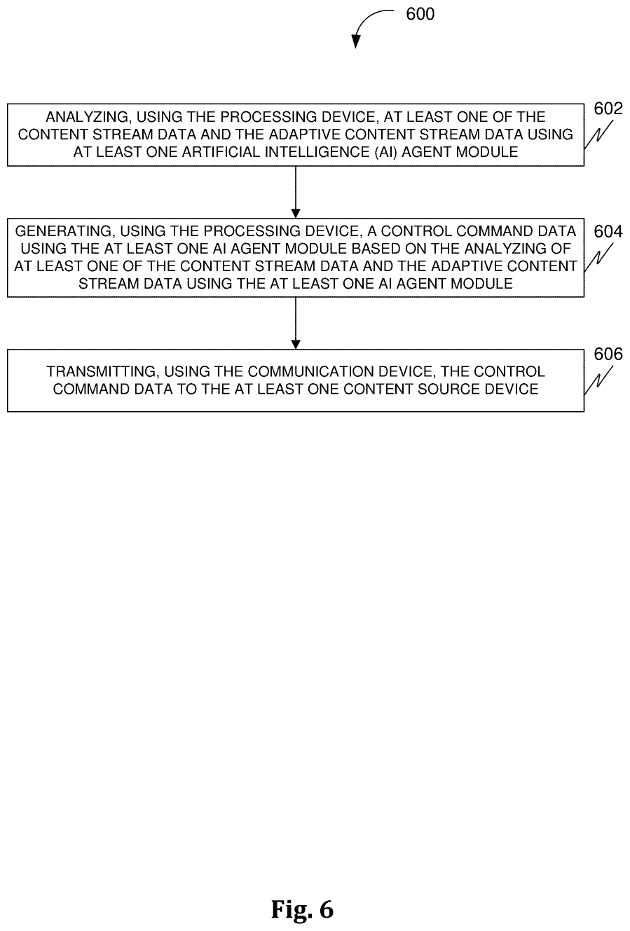

FIG. 6 illustrates a flowchart of a method 600 of provisioning digital content including generating, using the processing device 1204, a control command data using the at least one AI agent module, in accordance with some embodiments. Further, in some embodiments, the method 600 further may include a step 602 of analyzing, using the processing device 1204, one or more of the content stream data and the adaptive content stream data using one or more Artificial Intelligence (AI) agent modules 1402. Further, in some embodiments, the method 600 further may include a step 604 of generating, using the processing device 1204, a control command data using the one or more AI agent modules 1402 based on the analyzing of one or more of the content stream data and the adaptive content stream data using the one or more AI agent modules 1402. Further, in some embodiments, the method 600 further may include a step 606 of transmitting, using the communication device 1202, the control command data to the one or more content source devices 1206.

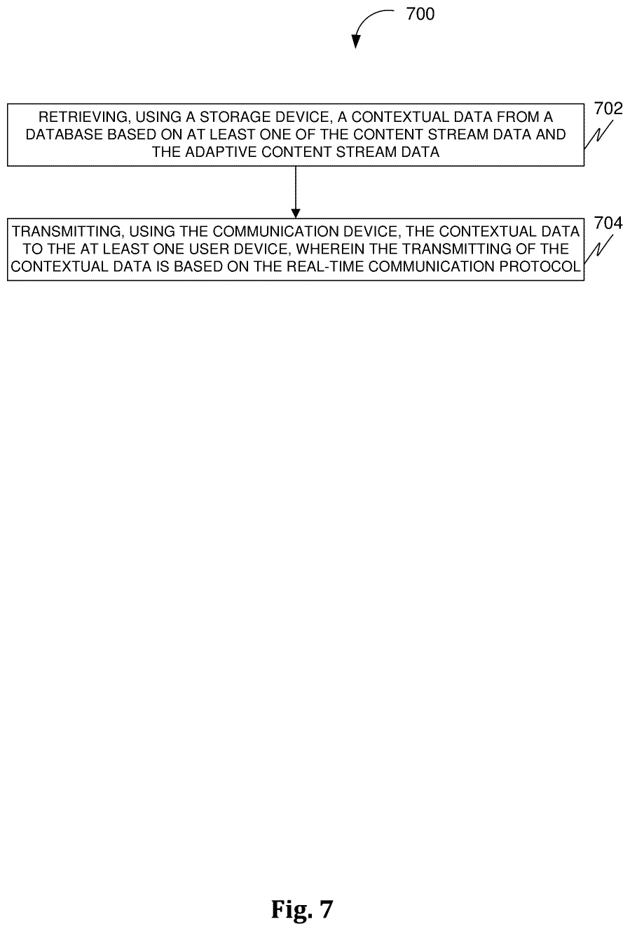

FIG. 7 illustrates a flowchart of a method 700 of provisioning digital content including retrieving, using a storage device 1302, a contextual data from a database, in accordance with some embodiments. Further, in some embodiments, the method 700 further may include a step 702 of retrieving, using a storage device 1302, a contextual data from a database based on one or more of the content stream data and the adaptive content stream data. Further, in some embodiments, the method 700 further may include a step 704 of transmitting, using the communication device 1202, the contextual data to the one or more user devices 1208. Further, the transmitting of the contextual data may be based on the real-time communication protocol.

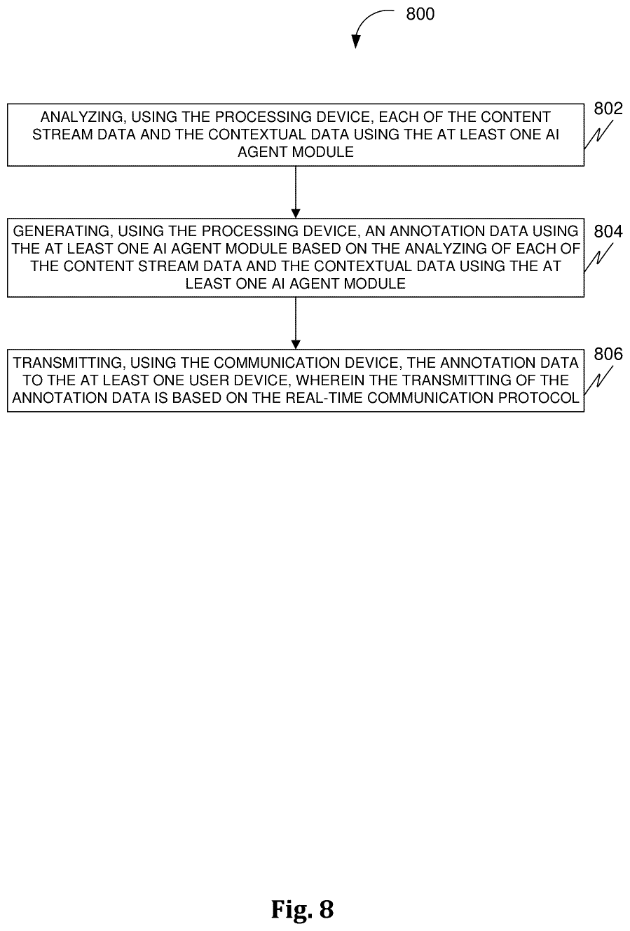

FIG. 8 illustrates a flowchart of a method 800 of provisioning digital content including generating, using the processing device 1204, an annotation data using the at least one AI agent module, in accordance with some embodiments. Further, in some embodiments, the method 800 further may include a step 802 of analyzing, using the processing device 1204, each of the content stream data and the contextual data using the one or more AI agent modules 1402. Further, in some embodiments, the method 800 further may include a step 804 of generating, using the processing device 1204, an annotation data using the one or more AI agent modules 1402 based on the analyzing of each of the content stream data and the contextual data using the one or more AI agent modules 1402. Further, in some embodiments, the method 800 further may include a step 806 of transmitting, using the communication device 1202, the annotation data to the one or more user devices 1208. Further, the transmitting of the annotation data may be based on the real-time communication protocol.

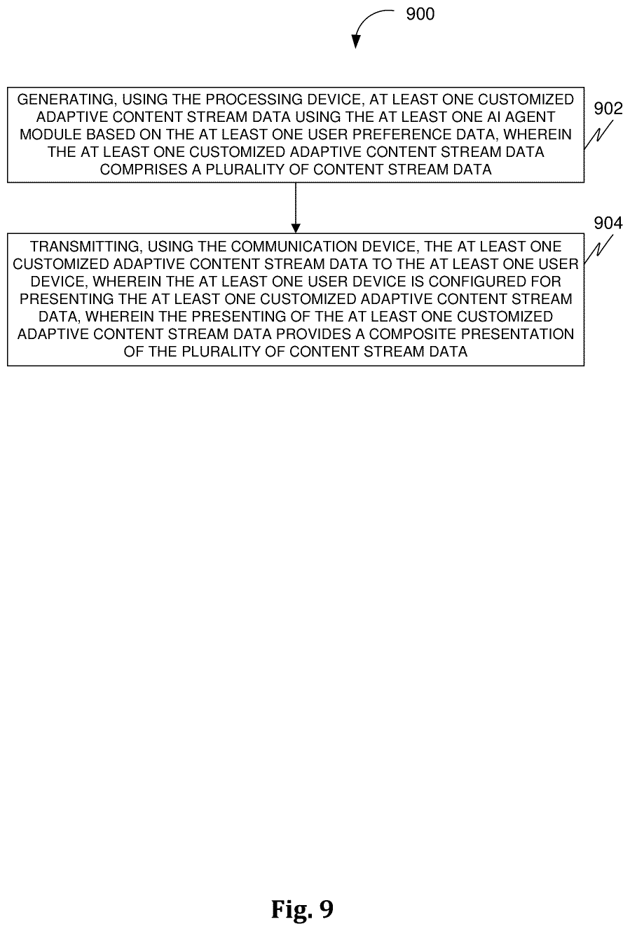

FIG. 9 illustrates a flowchart of a method 900 of provisioning digital content including generating, using the processing device 1204, at least one customized adaptive content stream data using the at least one AI agent module, in accordance with some embodiments. Further, in some embodiments, the method 900 further may include a step 902 of generating, using the processing device 1204, one or more customized adaptive content stream data using the one or more AI agent modules 1402 based on the one or more user preference data. Further, the one or more customized adaptive content stream data comprises two or more content stream data. Further, in some embodiments, the method 900 further may include a step 904 of transmitting, using the communication device 1202, the one or more customized adaptive content stream data to the one or more user devices 1208. Further, the one or more user devices 1208 may be configured for presenting the one or more customized adaptive content stream data. Further, the presenting of the one or more customized adaptive content stream data may provide a composite presentation of the two or more content stream data.

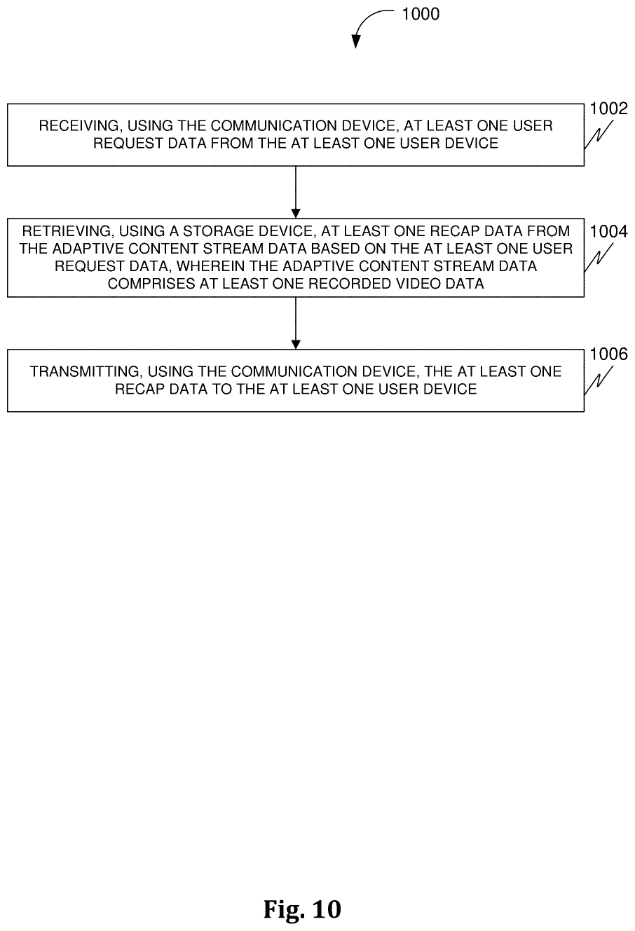

FIG. 10 illustrates a flowchart of a method 1000 of provisioning digital content including retrieving, using a storage device 1302, at least one recap data from the adaptive content stream data, in accordance with some embodiments. Further, in some embodiments, the method 1000 further may include a step 1002 of receiving, using the communication device 1202, one or more user request data from the one or more user devices 1208. Further, in some embodiments, the method 1000 further may include a step 1004 of retrieving, using a storage device 1302, one or more recap data from the adaptive content stream data based on the one or more user request data. Further, the adaptive content stream data includes one or more recorded video data. Further, in some embodiments, the method 1000 further may include a step 1006 of transmitting, using the communication device 1202, the one or more recap data to the one or more user devices 1208.

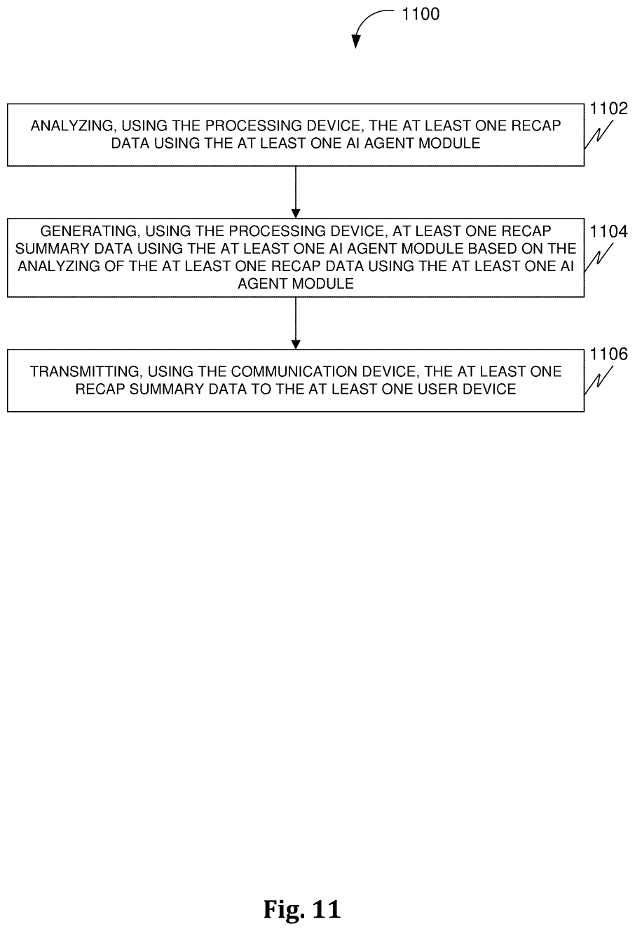

FIG. 11 illustrates a flowchart of a method 1100 of provisioning digital content including generating, using the processing device 1204, at least one recap summary data using the at least one AI agent module, in accordance with some embodiments. Further, in some embodiments, the method 1100 further may include a step 1102 of analyzing, using the processing device 1204, the one or more recap data using the one or more AI agent modules 1402. Further, in some embodiments, the method 1100 further may include a step 1104 of generating, using the processing device 1204, one or more recap summary data using the one or more AI agent modules 1402 based on the analyzing of the one or more recap data using the one or more AI agent modules 1402. Further, in some embodiments, the method 1100 further may include a step 1106 of transmitting, using the communication device 1202, the one or more recap summary data to the one or more user devices 1208.

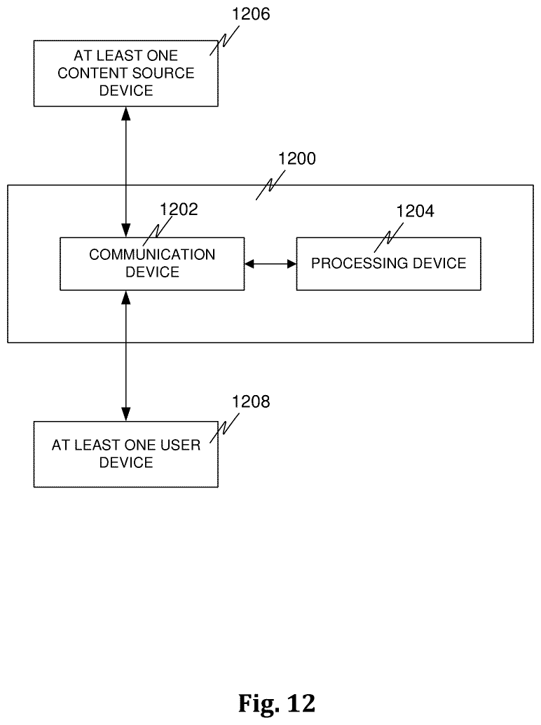

FIG. 12 illustrates a block diagram of a system 1200 of provisioning digital content, in accordance with some embodiments. Accordingly, the system 1200 may include a communication device 1202. Further, the communication device 1202 may be configured for receiving a content stream data from one or more content source devices 1206. Further, the receiving may be performed based on a real-time communication protocol. Further, the communication device 1202 may be configured for transmitting an adaptive content stream data to one or more user devices 1208 associated with one or more users. Further, the system 1200 may include a processing device 1204 communicatively coupled with the communication device 1202. Further, the processing device 1204 may be configured for generating the adaptive content stream data based on the one or more content stream data in accordance with an adaptive bitrate streaming protocol.

In some embodiments, the one or more content source devices 1206 include one or more sensor devices. Further, the one or more sensor devices may be configured for generating one or more sensor data representing one or more variables associated with an environment associated with the one or more content source devices 1206. Further, the one or more content source devices 1206 include the one or more sensor data

In some embodiments, the one or more user devices 1208 may be configured for presenting one or more Graphical User Interfaces. Further, the one or more Graphical User Interfaces may be configured to facilitate an interaction of the one or more users with the adaptive content stream data. Further, the processing device 1204 may be further configured for generating one or more user preference data based on the interaction of the one or more users with the adaptive content stream data. Further, the generating of the adaptive content stream data may be further based on the one or more user preference data.

In some embodiments, the one or more user preference data comprises one or more user interaction data indicating the interaction of the one or more users with the adaptive content stream data. Further, the communication device 1202 may be configured for transmitting one or more interaction data to one or more other user devices. Further, the one or more other user devices and the one or more user devices 1208 may be associated with a session.

In some embodiments, the receiving of the content stream data may include receiving two or more content stream data from two or more content source devices. Further, the processing device 1204 may be further configured for analyzing the two or more content stream data. Further, the processing device 1204 may be further configured for determining two or more time information associated with the two or more content stream data based on the analyzing of the two or more content stream data. Further, the generating of the adaptive content stream data may be further based on the determining of the two or more time information. Further, the generating of the adaptive content stream data includes generating a synchronized presentation data based on the two or more time information. Further, the adaptive content stream data includes the synchronized presentation data.

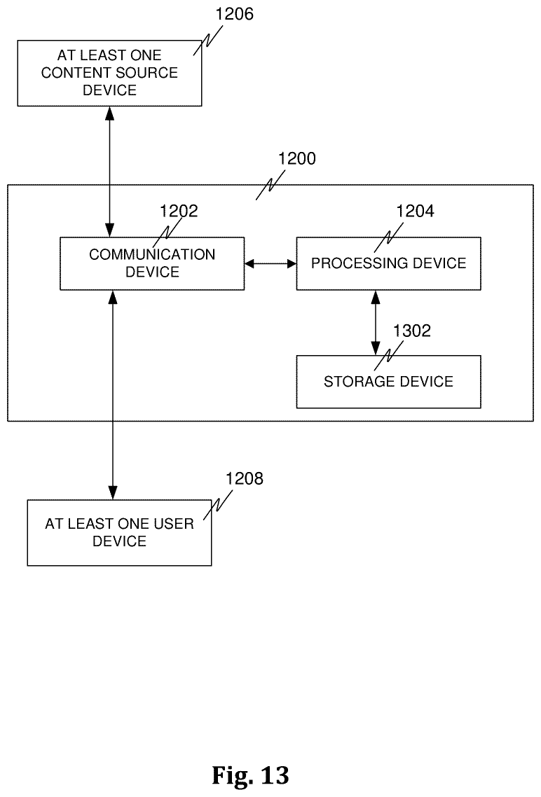

FIG. 13 illustrates a block diagram of the system 1200 of provisioning digital content, in accordance with some embodiments. Further, the system 1200 may further include a storage device 1302 communicatively coupled with the processing device 1204 and the communication device 1202. Further, the storage device 1302 may be configured for retrieving a historical data based on the one or more user preference data. Further, the communication device 1202 may be further configured for transmitting the historical data to the one or more user devices 1208.

Further, in some embodiments, the processing device 1204 may be further configured for analyzing one or more of the content stream data and the adaptive content stream data using one or more Artificial Intelligence (AI) agent modules 1402. Further, the processing device 1204 may be further configured for generating a control command data using the one or more AI agent modules 1402 based on the analyzing of one or more of the content stream data and the adaptive content stream data using the one or more AI agent modules 1402. Further, the communication device 1202 may be further configured for transmitting the control command data to the one or more content source devices 1206.

In some embodiments, the system 1200 may further include a storage device 1302 communicatively coupled with the processing device 1204 and the communication device 1202. Further, the storage device 1302 may be configured for retrieving a contextual data from a database based on one or more of the content stream data and the adaptive content stream data. Further, the communication device 1202 may be further configured for transmitting the contextual data to the one or more user devices 1208. Further, the transmitting of the contextual data may be based on the real-time communication protocol.

Further, in some embodiments, the processing device 1204 may be further configured for analyzing each of the content stream data and the contextual data using the one or more AI agent modules 1402. Further, the processing device 1204 may be further configured for generating an annotation data using the one or more AI agent modules 1402 based on the analyzing of each of the content stream data and the contextual data using the one or more AI agent modules 1402. Further, the communication device 1202 may be further configured for transmitting the annotation data to the one or more user devices 1208. Further, the transmitting of the annotation data may be based on the real-time communication protocol.

In some embodiments, the processing device 1204 may be further configured for generating one or more customized adaptive content stream data using the one or more AI agent modules 1402 based on the one or more user preference data. Further, the one or more customized adaptive content stream data comprises two or more content stream data. Further, the communication device 1202 may be further configured for transmitting the one or more customized adaptive content stream data to the one or more user devices 1208. Further, the one or more user devices 1208 may be configured for presenting the one or more customized adaptive content stream data. Further, the presenting of the one or more customized adaptive content stream data may provide a composite presentation of the two or more content stream data.

In some embodiments, the communication device 1202 may be further configured for receiving one or more user request data from the one or more user devices 1208, and transmitting one or more recap data to the one or more user devices 1208. Further, the system 1200 further includes a storage device 1302 communicatively coupled with the communication device 1202. Further, the storage device 1302 may be configured for retrieving the one or more recap data from the adaptive content stream data based on the one or more user request data. Further, the adaptive content stream data includes one or more recorded video data.

Further, in some embodiments, the processing device 1204 may be further configured for analyzing the one or more recap data using the one or more AI agent modules 1402. Further, the processing device 1204 may be further configured for generating one or more recap summary data using the one or more AI agent modules 1402 based on the analyzing of the one or more recap data using the one or more AI agent modules 1402. Further, the communication device 1202 may be further configured for transmitting the one or more recap summary data to the one or more user devices 1208.

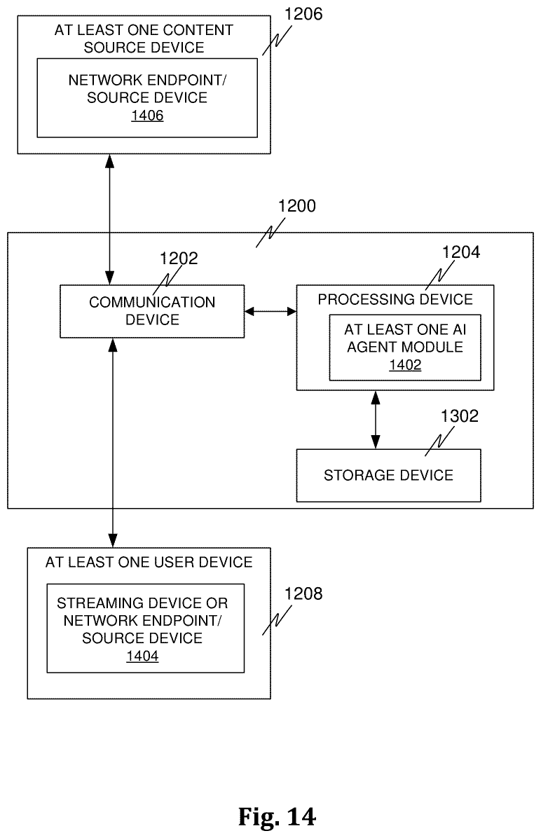

FIG. 14 illustrates a block diagram of the system 1200 for provisioning digital content, in accordance with some embodiments. Further, the one or more user devices 1208 comprise a streaming device or network endpoint/source device 1404. Further, the one or more content source devices 1206 comprise a network endpoint/source device 1406.

In some embodiments, the one or more user devices 1208 may be configured for presenting the adaptive content stream data. Further, the presenting of the adaptive content stream data includes presenting the synchronized presentation data. Further, the presenting of the synchronized presentation data provides synchronized presentation of the two or more content stream data.

In some embodiments, the transmitting may be performed based on one or more of the real-time communication protocol and the adaptive bitrate streaming protocol.

In some embodiments, the real-time communication protocol may correspond to one or more of WebRTC and a Hypertext Transfer Protocol.

In some embodiments, the adaptive bitrate streaming protocol may correspond to HTTP live streaming.

In some embodiments, the adaptive bitrate streaming protocol may correspond to Dynamic Adaptive Streaming over HTTP.

In some embodiments, the content stream data may include an audio data.

In some embodiments, the content stream data may include a video data.

In some embodiments, the content stream data may include a text data.

In some embodiments, the generating may include determining one or more network condition data representing one or more network qualities of one or more networks. Further, the communication device 1202 may communicate with the one or more user devices 1208 using the one or more networks. Further, the generating may include decoding the adaptive content stream data based on the one or more network condition data.

In some embodiments, the one or more content source devices 1206 may include a camera which may be configured to generate one or more of an image data and a video data.

In some embodiments, the one or more content source devices 1206 may include a sound capturing device which may be configured to generate an audio data.

In some embodiments, the one or more content source devices 1206 may include a content server.

In some embodiments, the one or more content source devices 1206 may include an Internet of Things device.

In some embodiments, the one or more content source devices 1206 may include a plurality of cameras which may be configured to generate one or more of an image data and a video data.

In some embodiments, the two or more cameras may include a first camera and a second camera. Further, the first camera may be associated with a first field of view, and the second camera may be associated with a second field of view. Further, the first field of view may be a first region of space in relation to the first camera. Further, light originating within the first region of space may be receivable by the first camera. Further, the second field of view may be a second region of space in relation to the second camera. Further, light originating within the second region of space may be receivable by the second camera. Further, at least one point may be common between the first region of space and the second region of space.

In some embodiments, the two or more cameras may include a first camera and a second camera. Further, the first camera may be associated with a first field of view, and the second camera may be associated with a second field of view. Further, the first field of view may be a first region of space in relation to the first camera. Further, light originating within the first region of space may be receivable by the first camera. Further, the second field of view may be a second region of space in relation to the second camera. Further, light originating within the second region of space may be receivable by the second camera. Further, each of the first region of space and the second region of space may not include one or more common points.

In some embodiments, the one or more user preference data may be based on a user role.

In some embodiments, the user role may correspond to a role of the one or more users.

In some embodiments, the role includes a sports coach. Further, the sports coach may perform one or more of teaching, training one or more of a sport individual and a team, and decision making about a performance of one or more of the sport individual and the team.

In some embodiments, the interaction may correspond to one or more of switching between the historical data and the adaptive content stream data, and combining the historical data and the adaptive content stream data. Further, the adaptive content stream data may correspond to a live feed. Further, the live feed may represent a real-time transmission of the content stream data from the one or more content source devices 1206 to the one or more user devices 1208.

In some embodiments, the historical data may correspond to an archived video. Further, the archived video may represent a recorded video data stored in a storage device 1202.

In some embodiments, the one or more content source devices 1206 may include a camera.

In some embodiments, the control command data includes a command for controlling one or more of a physical state of the camera and an operation state of the camera.

In some embodiments, the camera may be associated with the physical state. Further, a field of view of the camera may be based on the physical state of the camera. Further, the physical state of the camera may be controllable based on the control command data.

In some embodiments, the control command may include one or more of a pan command, a tilt command, and a rotate command. Further, the physical state includes a first physical state, a first field of view associated with the first physical state, a second physical state, and a second field of view associated with the second physical state. Further, each of the first field of view and the second field of view may not include one or more common points.

In some embodiments, the camera may be configured to perform one or more physical movements in one or more directions to change the physical state of the camera from the first physical state to the second physical state.

In some embodiments, the one or more control commands may include a zoom command. Further, the physical state includes a first physical state, a first field of view associated with the first physical state, a second physical state, and a second field of view associated with the second physical state. Further, the camera may be configured for changing the physical state of the camera from the first physical state to the second physical state based on one or more physical movements of lens of the camera. Further, the changing of the physical state of the camera from the first physical state to the second physical state includes changing a focal length of the camera.

In some embodiments, the camera may be associated with one or more operational states. Further, the one or more operational states may correspond to one or more of an on state of the camera and an off state of the camera.

In some embodiments, the one or more AI agent modules 1402 may correspond to a situation room.

In some embodiments, the one or more AI agent modules 1402 include an intelligent agent. Further, the intelligent agent may be configured to perform one or more specific tasks autonomously.

In some embodiments, the one or more specific tasks may be performed by the one or more AI agent modules 1402 through one or more of an interaction with an environment, a collection of one or more data, and use of the one or more data.

In some embodiments, the communication device 1202 includes a plurality of channels. Further, the communication device 1202 may be configured to transmit the adaptive content stream data through one or more of the plurality of channels.

In some embodiments, the contextual data may correspond to a historical feed. Further, the historical feed represents a recorded video data stored in the storage device 1202.

In some embodiments, the transmitting facilitates a Graphical User Interface of the one or more user devices 1208 to automatically switch between one or more of the adaptive content stream data and the contextual data.

In some embodiments, the analyzing and the generating may be further based on two or more AI agent modules. Further, each of the two or more AI agent modules includes an intelligent agent. Further, the intelligent agent may be configured to perform one or more specific tasks autonomously.

In some embodiments, the contextual data may include one or more regulatory guidelines. Further, the one or more regulatory guidelines correspond to a rule established by a regulatory authority.

In some embodiments, the contextual data may include one or more historical analytics. Further, the one or more historical analytics correspond to an analysis of a past data.

In some embodiments, the contextual data may include one or more geographical data. Further, the one or more geographical data comprises an information related to a specific area on earth.

In some embodiments, the annotation data may include a summary.

In some embodiments, the contextual data may include research articles.

In some embodiments, the contextual data may include a patient history.

In some embodiments, the adaptive content stream data may include multi-modal data. Further, the adaptive content stream data comprising the multi-modal data may be characterized by one or more modalities. Further, the one or more modalities correspond to one or more representations of data.

In some embodiments, the one or more modalities may correspond to one or more of an audio data, a video data, and a text data.

In some embodiments, the one or more customized adaptive content stream data comprises the adaptive content stream data associated with one or more customizations.

In some embodiments, the one or more customizations include overlaying a three-dimensional (3D) model data over the adaptive content stream data.

In some embodiments, the 3D model data may correspond to a 3D skeleton. Further, the one or more users comprise a coach. Further, the adaptive content stream data corresponds to player's shot.

In some embodiments, the one or more customizations may include combining the adaptive content stream data with a map tool. Further, the map tool facilitates the one or more users to track a plurality of incidents.

In some embodiments, the one or more users may include a dispatcher. Further, the two or more incidents correspond to an accident.

In some embodiments, the one or more user devices 1208 include a custom player. Further, the custom player corresponds to a content player. Further, the content player may be customizable based on the one or more user preference data.

In some embodiments, the method 400 may further include receiving, using the communication device 1202, one or more metadata. Further, the one or more metadata includes one or more state data corresponding to the state of the one or more content stream data. Further, the communication device 1202 may be implemented with a data channel. Further, the method 400 may include analyzing, using the processing device 1204, the one or more metadata using the one or more AI agent modules 1402. Further, the method 400 may include identifying, using the processing device 1204, one or more event data using the one or more AI agent modules 1402 based on the analyzing of the one or more metadata using the one or more AI agent modules 1402. Further, the one or more event data represent an event indicating an alteration in the one or more state data. Further, the method 400 may include generating, using the processing device 1204, a statement data using the one or more AI agent modules 1402 based on the identifying of the event data. Further, the statement data represents the alteration in the state data. Further, the method 400 may further include transmitting, using the communication device 1202, the statement data to the one or more user devices 1208 based on the real-time communication protocol.

In some embodiments, the alteration in the state of the one or more content data may be based on an interaction of the one or more users with the adaptive content stream data through a Graphical User Interface.

In some embodiments, the state of the content stream data in the one or more content source devices 1206 and the state of the adaptive content stream data in the one or more user devices 1208 may be identical.

In some embodiments, the one or more users may be a doctor. Further, the one or more content source devices 1206 may correspond to a diagnostic device. Further, the adaptive content stream data may correspond to one or more of a patient model and a diagnostic.

In some embodiments, the patient model may correspond to a virtual representation of a patient body with one or more properties obtained from patient data.

In some embodiments, the diagnostic may correspond to a medical test.

In some embodiments, the one or more users may correspond to a sports analyst. Further, the one or more summary data includes a post-game summary.

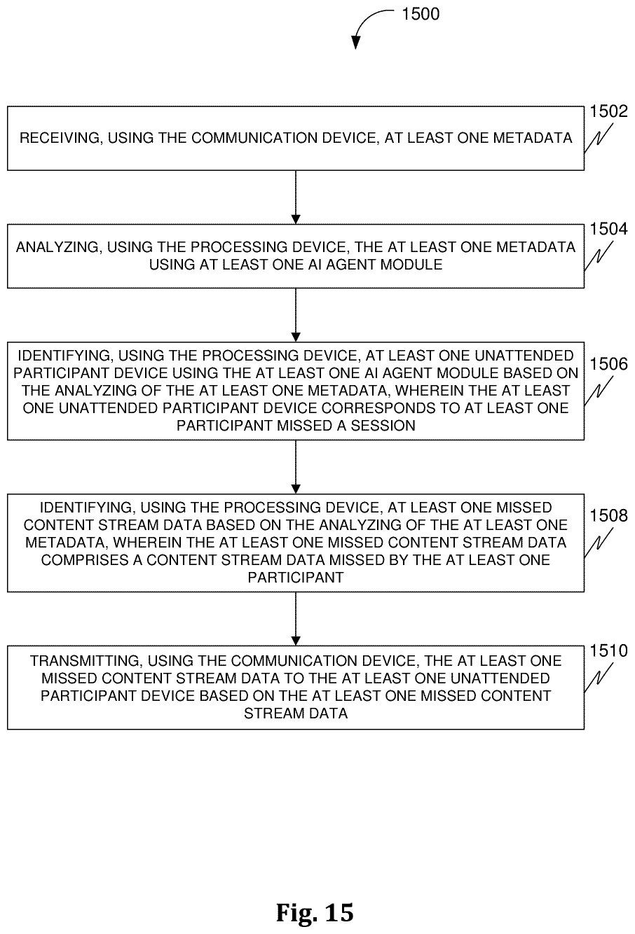

FIG. 15 illustrates a flowchart of a method 1500 of provisioning digital content including identifying, using the processing device 1204, at least one missed content stream data, in accordance with some embodiments. Further, in some embodiments, the method 1500 further may include a step 1502 of receiving, using the communication device 1202, one or more metadata. Further, in some embodiments, the method 1500 further may include a step 1504 of analyzing, using the processing device 1204, the one or more metadata using one or more AI agent modules 1402. Further, in some embodiments, the method 1500 further may include a step 1506 of identifying, using the processing device 1204, one or more unattended participant devices using the one or more AI agent modules 1402 based on the analyzing of the one or more metadata. Further, the one or more unattended participant devices correspond to one or more participants in a session. Further, in some embodiments, the method 1500 further may include a step 1508 of identifying, using the processing device 1204, one or more missed content stream data based on the analyzing of the one or more metadata. Further, the one or more missed content stream data includes a content stream data missed by the one or more participants. Further, in some embodiments, the method 1500 further may include a step 1510 of transmitting, using the communication device 1202, the one or more missed content stream data to the one or more unattended participant devices based on the identifying of the one or more missed content stream data.

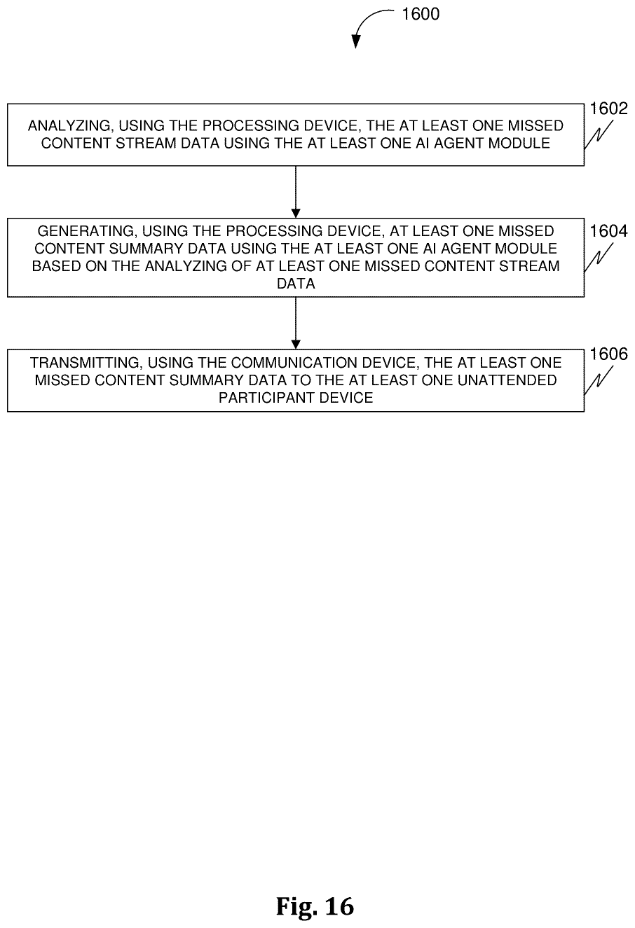

FIG. 16 illustrates a flowchart of a method 1600 of provisioning digital content including generating, using the processing device 1204, at least one missed content summary data, in accordance with some embodiments. Further, in some embodiments, the method 1600 further may include a step 1602 of analyzing, using the processing device 1204, the one or more missed content stream data using the one or more AI agent modules 1402. Further, in some embodiments, the method 1600 further may include a step 1604 of generating, using the processing device 1204, one or more missed content summary data using the one or more AI agent modules 1402 based on the analyzing of one or more missed content stream data. Further, in some embodiments, the method 1600 further may include a step 1606 of transmitting, using the communication device 1202, the one or more missed content summary data to the one or more unattended participant devices.

In some embodiments, the one or more missed content stream data comprises a multi-modal summary. Further, the multi-modal summary combines two or more data characterized by one or more modalities. Further, the one or more modalities correspond to one or more representations of the two or more data.

In some embodiments, the database may be an external source.

In some embodiments, the annotation data may include an alert.

In some embodiments, the one or more AI agent modules 1402 may include a vision AI model. Further, the vision AI model may be trained to understand and process a language and an image simultaneously.

In some embodiments, the vision AI model may be configured to detect one or more events in real-time.

In some embodiments, the one or more events may correspond to an emergency situation.

In some embodiments, the vision AI model may be configured to track a specific object based on the one or more events.

In some embodiments, the specific object may correspond to a vehicle. Further, the one or more events may correspond to an accident.

In some embodiments, the vision AI model may be configured to generate the adaptive content stream data based on the one or more events.

In some embodiments, the interaction further may correspond to selecting a specific layout. Further, the specific layout corresponds to an arrangement of the historical data and the adaptive content stream data.

In some embodiments, the one or more events may correspond to an obscured camera view. Further, the obscured camera view corresponds to a camera view associated with a poor clarity.

In some embodiments, the one or more regulatory guidelines may correspond to a traffic regulation.

In some embodiments, the live feed includes multi-angle live feeds.

In some embodiments, the interaction may correspond to one or more of enabling and disabling the adaptive content stream data by the one or more users to focus on an overhead camera feed to review shot mechanics during a basketball training session.

In some embodiments, the one or more of the enabling and the disabling of the adaptive content stream data may take place to focus on active events during an emergency response session.

Accordingly, in some embodiments, the one or more user devices 1208 may be configured to execute an application, such as, but not limited to, a browser and a customized computer application configured to cooperate with the system. Accordingly, the application may be configured to present the one or more adaptive content stream data on a presentation device associated with the one or more user devices 1208.

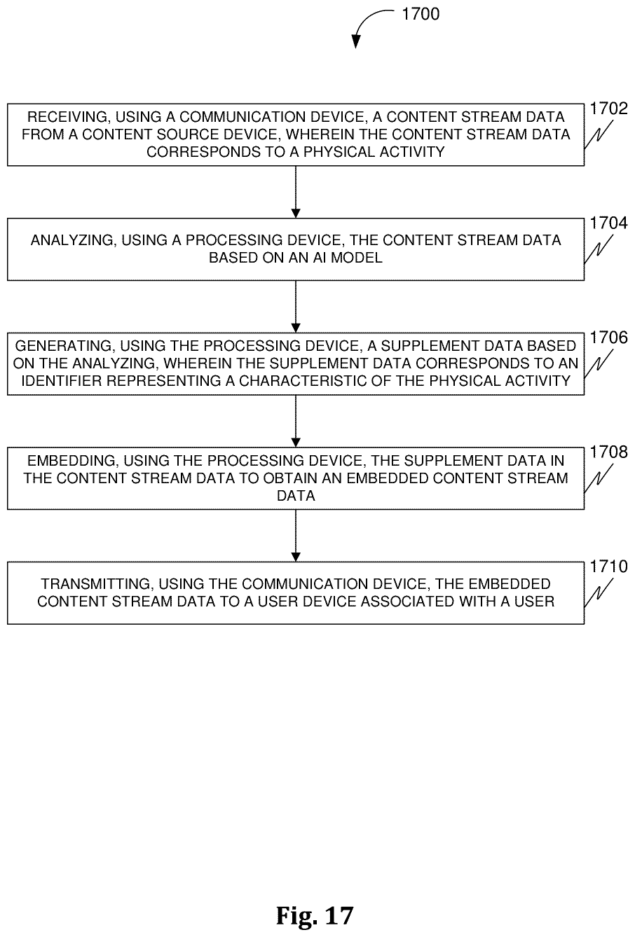

FIG. 17 illustrates a flowchart of a method 1700 of facilitating a video stream broadcasting, in accordance with some embodiments. Further, the method 1700 may include a step 1702 of receiving, using a communication device 1902, a content stream data from a content source device. Further, the content stream data corresponds to a physical activity. Further, the method 1700 may include a step 1704 of analyzing, using a processing device 1904, the content stream data using an AI-driven analysis model. Further, the method 1700 may include a step 1706 of generating, using the processing device 1904, a supplement data based on the analyzing. Further, the supplement data corresponds to an identifier representing a characteristic of the physical activity. Further, the method 1700 may include a step 1708 of embedding, using the processing device 1904, the supplement data in the content stream data to obtain an embedded content stream data. Further, the method 1700 may include a step 1710 of transmitting, using the communication device 1902, the embedded content stream data to a user device associated with a user.

In some embodiments, the physical activity may be associated with an object. Further, the analyzing is based on one or more of a key point of an object and a skeletal motion of an object. Further, the physical activity is associated with an object.

In some embodiments, the analyzing of the content stream data is further based on one or more of a pose landmark detection, an action recognition, a motion tracking, and a three-dimensional kinematics modeling.

In some embodiments, the analyzing of the content stream data includes extracting a pose landmark data. Further, the pose landmark data corresponds to the key point in the object.

In some embodiments, the supplement data includes a pose data based on the pose landmark data. Further, the pose data corresponds to a pose of the object. Further, the characteristic of the object corresponds to the pose of the object.

In some embodiments, the key point represents one or more of two or more object parts. Further, the object may be associated with the two or more object parts.

In some embodiments, the AI-driven analysis model includes a machine learning model. Further, the machine learning model is based on one or more of a deep learning network, a classic computer vision approach, a hybrid AI system leveraging neural networks, a heuristic rule, and a statistical model.

In some embodiments, the analyzing of the content stream data includes identifying an activity data. Further, the activity data corresponds to one or more of two or more activities. Further, the physical activity comprises the two or more activities.

In some embodiments, the identifier corresponds to an event-based metadata. Further, the event-based metadata corresponds to at least one of an activity marker, a phase transition, a motion cue, and a contextual signal representing the one or more of the two or more activities.

In some embodiments, the analyzing comprises identifying a phase data corresponding to a phase of one or more of two or more activities. Further, the physical activity includes the two or more activities. Further, the two or more activities may be associated with two or more phases comprising the phase. Further, the characteristic corresponds to the phase.

In some embodiments, the identifier corresponds to a phase marker representing the phase.

In some embodiments, the embedded content stream data includes a metadata. Further, the metadata includes each of a content stream metadata corresponding to the content stream data and a supplement data.

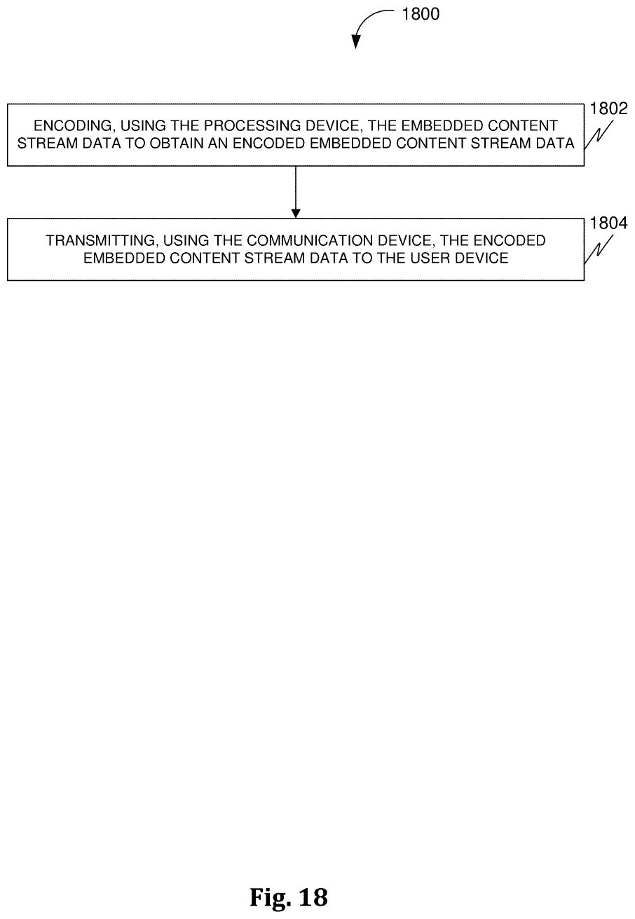

FIG. 18 illustrates a flowchart of a method 1800 of facilitating a video stream broadcasting including encoding, using the processing device 1904, the embedded content stream data to obtain an encoded embedded content stream data, in accordance with some embodiments. Further, in some embodiments, the method 1800 further may include a step 1802 of encoding, using the processing device 1904, the embedded content stream data to obtain an encoded embedded content stream data. Further, in some embodiments, the method 1800 further may include a step 1804 of transmitting, using the communication device 1902, the encoded embedded content stream data to the user device.

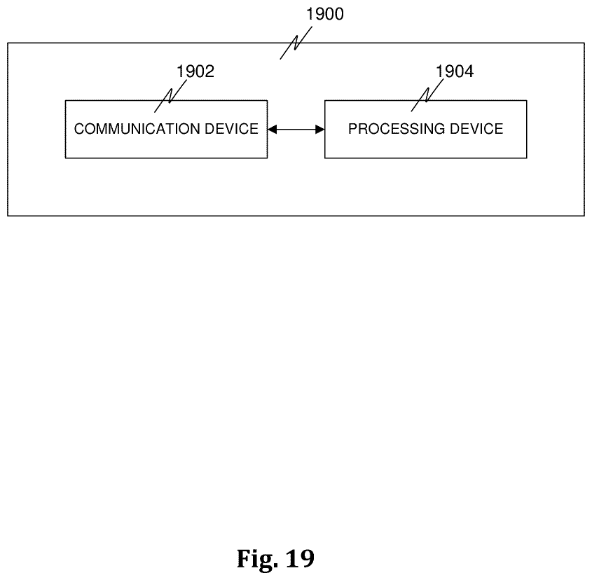

FIG. 19 illustrates a block diagram of a system 1900 of facilitating a video stream broadcasting, in accordance with some embodiments. Accordingly, the system 1900 may include a communication device 1902. Further, the communication device 1902 may be configured for receiving a content stream data from a content source device. Further, the content stream data corresponds to a physical activity. Further, the communication device 1902 may be configured for transmitting an embedded content stream data to a user device associated with a user. Further, the system 1900 may include a processing device 1904 communicatively coupled with the communication device 1902. Further, the processing device 1904 may be configured for analyzing the content stream data using an AI-driven analysis model. Further, the processing device 1904 may be configured for generating a supplement data based on the analyzing. Further, the supplement data corresponds to an identifier representing a characteristic of the physical activity. Further, the processing device 1904 may be configured for embedding the supplement data in the content stream data to obtain the embedded content stream data.

In some embodiments, the physical activity may be associated with an object. Further, the analyzing is based on one or more of a key point of an object and a skeletal motion of an object. Further, the physical activity is associated with an object.

In some embodiments, the analyzing is further based on one or more of a pose landmark detection, an action recognition, a motion tracking, and a three-dimensional kinematics modeling.

In some embodiments, the analyzing includes extracting a pose landmark data. Further, the pose landmark data corresponds to the key point in the object.

In some embodiments, the supplement data includes a pose data based on the pose landmark data. Further, the pose data corresponds to a pose of the object. Further, the characteristic corresponds to the pose.

In some embodiments, the key point represents one or more of two or more object parts. Further, the object may be associated with the two or more object parts.

In some embodiments, the AI-driven analysis model includes a machine learning model. Further, the machine learning model is based on one or more of a deep learning network, a classic computer vision approach, a hybrid AI system leveraging neural networks, a heuristic rule, and a statistical model.

In some embodiments, the analyzing includes identifying an activity data. Further, the activity data corresponds to one or more of two or more activities. Further, the physical activity may be associated with the two or more activities.

In some embodiments, the identifier corresponds to an event-based metadata. Further, the event-based metadata corresponds to at least one of an activity marker, a phase transition, a motion cue, and a contextual signal representing the one or more of the two or more activities.

In some embodiments, the analyzing comprises identifying a phase data corresponding to a phase of one or more of two or more activities. Further, the physical activity includes the two or more activities. Further, the two or more activities may be associated with two or more phases comprising the phase. Further, the characteristic corresponds to the phase.

In some embodiments, the identifier corresponds to a phase marker representing the phase.

In some embodiments, the embedded content stream data includes a metadata. Further, the metadata includes each of a content stream metadata corresponding to the content stream data and a supplement data.

In some embodiments, the processing device 1904 may be further configured for encoding the embedded content stream data to obtain an encoded embedded content stream data. Further, the communication device 1902 may be further configured for transmitting the encoded embedded content stream data to the user device.

In some embodiments, the object corresponds to a human body.

In some embodiments, the physical activity occurs over a time interval. Further, the two or more activities occur at two or more time instances.

In some embodiments, the identifier corresponds to two or more activity markers representing the two or more activities.

In some embodiments, the content stream data includes a video data.

In some embodiments, the content source data includes a camera.

In some embodiments, the physical activity includes a sport activity.

In some embodiments, the user device is associated with a multimedia playback environment. Further, the multimedia playback environment corresponds to one or more of a standalone media player, a web-based media player, a smart television application, an augmented reality display system, and a virtual reality display system.

In some embodiments, the embedded content stream data includes a video data.

In some embodiments, the content stream data includes a video data associated with two or more frames. Further, the pose landmark data includes two or more pose landmark data corresponding to two or more frames.

In some embodiments, the two or more frames include each of a first frame and a second frame. Further, the two or more pose landmark data includes each of a first pose landmark data corresponding to the first frame and a second pose landmark data corresponding to the second frame.

In some embodiments, the content stream data includes a video data associated with two or more frames. Further, the activity data includes two or more activity data corresponding to the two or more frames.

In some embodiments, the two or more frames include each of a first frame and a second frame. Further, the two or more activity data includes each of a first activity data corresponding to the first frame and a second activity data corresponding to the second frame.

In some embodiments, the streaming preference further corresponds to a parameter required for initializing a multimedia playback environment. Further, the user device may be associated with the multimedia playback environment.

In some embodiments, the content stream data may be associated with a container format. Further, the container format corresponds to one or more of an MP4, an MKV, a WebM, a TS, and a multimedia container format.

In some embodiments, the receiving may be based on a streaming and transmission protocol. Further, the streaming and transmission protocol includes one or more of an HTTP-based adaptive streaming protocol, a low-latency streaming protocol, and a traditional streaming method.

In some embodiments, the HTTP-based adaptive streaming protocol includes one or more of DASH and HLS.

In some embodiments, the low-latency streaming protocol includes one or more of WebRTC and a QUIC-based streaming.

In some embodiments, the traditional streaming methods include one or more of RTP, RTMP, and SRT.

In some embodiments, the content stream data includes two or more content stream data. Further, the embedded content stream data includes two or more embedded content stream data corresponding to the two or more content stream data. Further, the two or more embedded content stream data occur at two or more time instances.

In some embodiments, the two or more embedded content stream data includes a first embedded content stream data corresponding to a first time instance and a second embedded content stream data corresponding to a second time instance. Further, the two or more time instances include each of the first time instance and the second time instance.

In some embodiments, the embedded content stream data is based on a video compression standard. Further, the video compression standard corresponds to one or more of an H.264, an H.265, an AV1, a VVC, and similar encoding formats. Further, the VCC corresponds to an H.266.

In some embodiments, the encoding corresponds to a multi-dimensional metadata encoding. Further, the multi-dimensional metadata encoding corresponds to a representation of an object in one or more of a three-dimensional coordinate system, a six-dimensional coordinate system, and an extended space-time coordinate system. Further, the physical activity may be associated with an object.

In some embodiments, the six-dimensional coordinate system represents each of an object pose and an object rotation based on a six parameters.

In some embodiments, the object pose corresponds to a position of the object and orientation of the object in a three-dimensional space.

In some embodiments, the physical activity may be associated with an object. Further, the user device may be associated with a presentation device. Further, the presentation device may be configured to present one or more of a three-dimensional data corresponding to a three-dimensional view of the object and a six-dimensional data corresponding to a six-dimensional view of the object. Further, the embedded content stream data includes one or more of the three-dimensional data and the six-dimensional data.

In some embodiments, the content source device includes two or more content source devices. Further, the content stream data includes two or more content stream data from the two or more content stream devices. Further, the two or more content stream data corresponds to the physical activity in two or more views.

In some embodiments, the user device may be associated with a user presentation device. Further, the user presentation device may be configured for presenting the two or more content stream data.

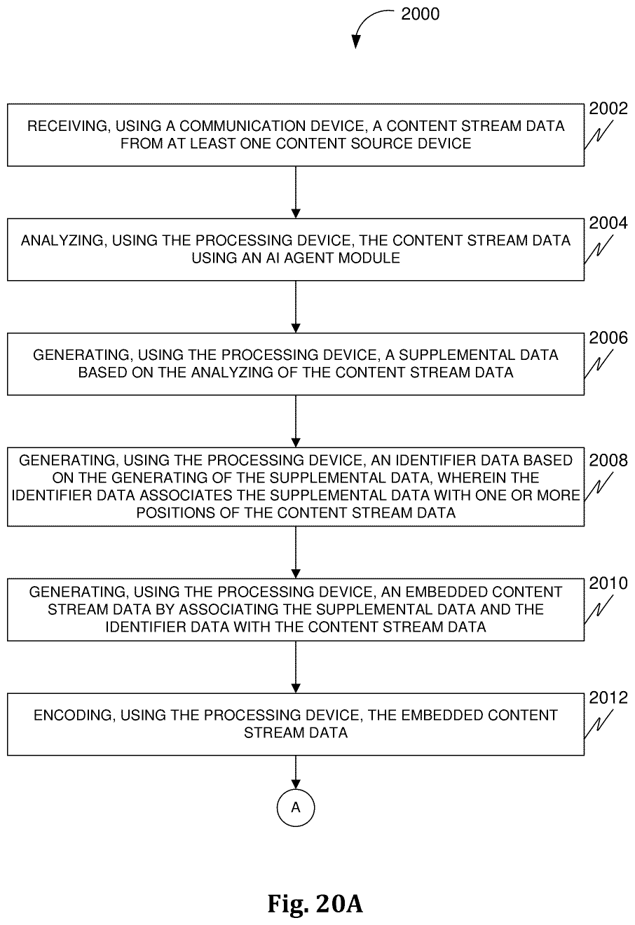

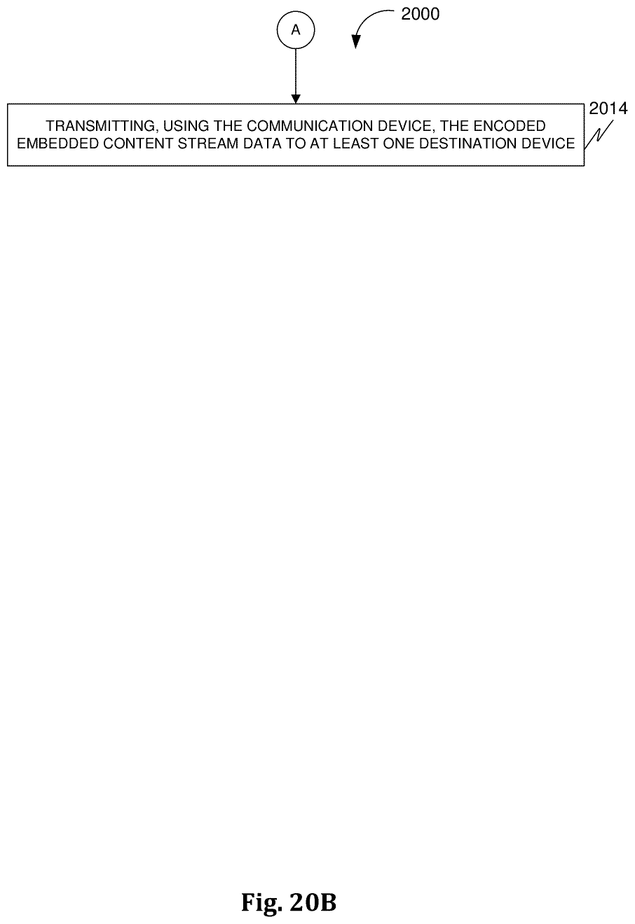

FIG. 20A and FIG. 20B illustrate a flowchart of a method 2000 of facilitating a video stream broadcast, in accordance with some embodiments. Further, the method 2000 may include a step 2002 of receiving, using a communication device 2102, a content stream data from one or more content source devices 2106. Further, the method 2000 may include a step 2004 of analyzing, using the processing device 2104, the content stream data using an AI agent module. Further, the method 2000 may include a step 2006 of generating, using the processing device 2104, a supplemental data based on the analyzing of the content stream data. Further, the method 2000 may include a step 2008 of generating, using the processing device 2104, an identifier data based on the generating of the supplemental data. Further, the identifier data associates the supplemental data with one or more positions of the content stream data. Further, the method 2000 may include a step 2010 of generating, using the processing device 2104, an embedded content stream data by associating the supplemental data and the identifier data with the content stream data. Further, the method 2000 may include a step 2012 of encoding, using the processing device 2104, the embedded content stream data. Further, the method 2000 may include a step 2014 of transmitting, using the communication device 2102, the encoded embedded content stream data to one or more destination devices 2108.

In some embodiments, the identifier data includes one or more of a timestamp, a frame index, a segment identifier, a hash, and a timecode.

In some embodiments, the associating of the supplemental data and the identifier data with the content stream data includes embedding the supplemental data in-band as timed metadata synchronized to video frames.

In some embodiments, the associating of the supplemental data and the identifier data includes generating a sidecar metadata stream synchronized to the content stream data.

In some embodiments, the supplemental data includes one or more of an object tracking result, a pose data, a keypoint data, an event marker, a detected action, a transcribed audio, and a generated scene description.

In some embodiments, the method 2000 may further include storing, using a storage device 2202, the supplemental data and the identifier data for retrieval during playback of a recorded content stream data.

In some embodiments, the transmitting of the encoded embedded content stream data uses one or more of WebRTC, RTSP, SRT, HLS, and DASH.

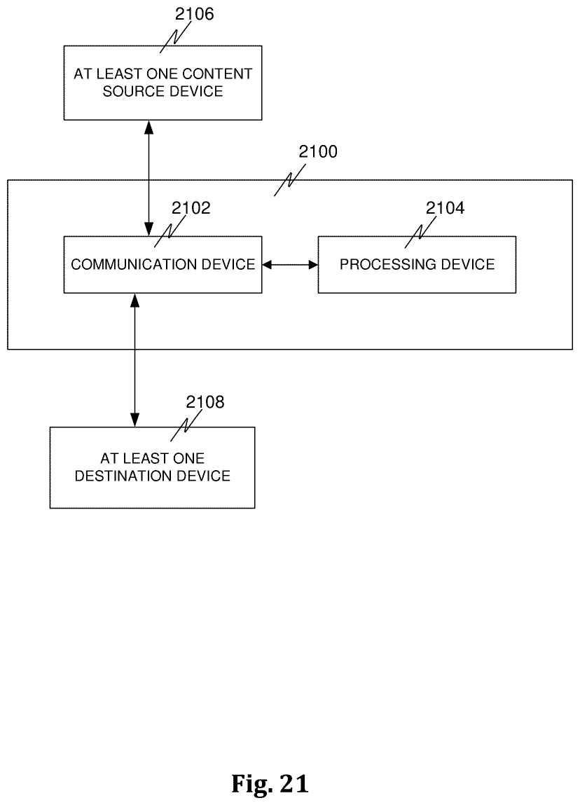

FIG. 21 illustrates a block diagram of a system 2100 of facilitating a video stream broadcast, in accordance with some embodiments. Further, the system 2100 may include a communication device 2102. Further, the communication device 2102 may be configured for receiving a content stream data from one or more content source devices 2106. Further, the communication device 2102 may be configured for transmitting an encoded embedded content stream data to one or more destination devices 2108. Further, the system 2100 may include a processing device 2104 communicatively coupled with the communication device 2102. Further, the processing device 2104 may be configured for analyzing the content stream data using an AI agent module. Further, the processing device 2104 may be configured for generating a supplemental data based on the analyzing of the content stream data. Further, the processing device 2104 may be configured for generating an identifier data based on the generating of the supplemental data. Further, the identifier data associates the supplemental data with one or more positions of the content stream data. Further, the processing device 2104 may be configured for generating the embedded content stream data by associating the supplemental data and the identifier data with the content stream data. Further, the processing device 2104 may be configured for encoding the embedded content stream data.

In some embodiments, the one or more destination devices 2108 may be configured for extracting the supplemental data. Further, the one or more destination devices 2108 may be configured for rendering an overlay based on the supplemental data.

In some embodiments, the identifier data supports random access to the supplemental data for a selected time interval.

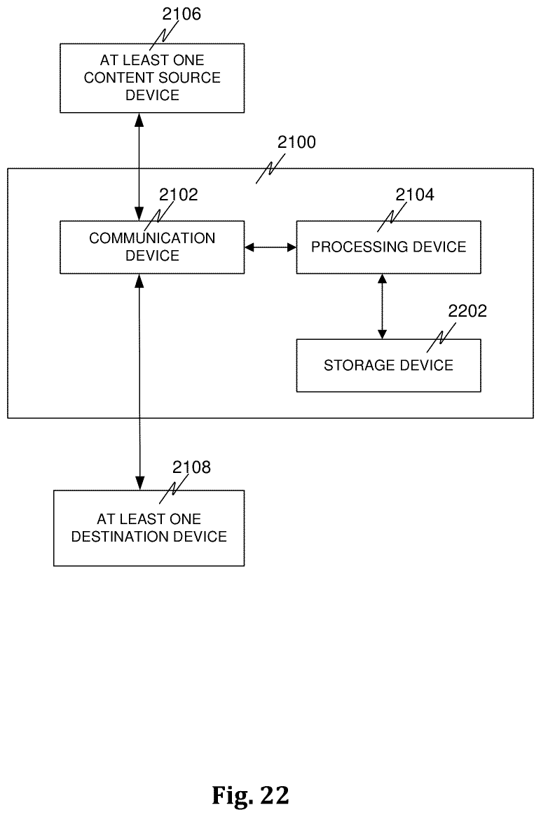

FIG. 22 illustrates a block diagram of the system 2100 of facilitating a video stream broadcast, in accordance with some embodiments. In some embodiments, the system 2100 may further include a storage device 2202 communicatively coupled with the processing device 2104. Further, the storage device 2202 may be configured for storing the supplemental data and the identifier data for retrieval during playback of a recorded content stream data.

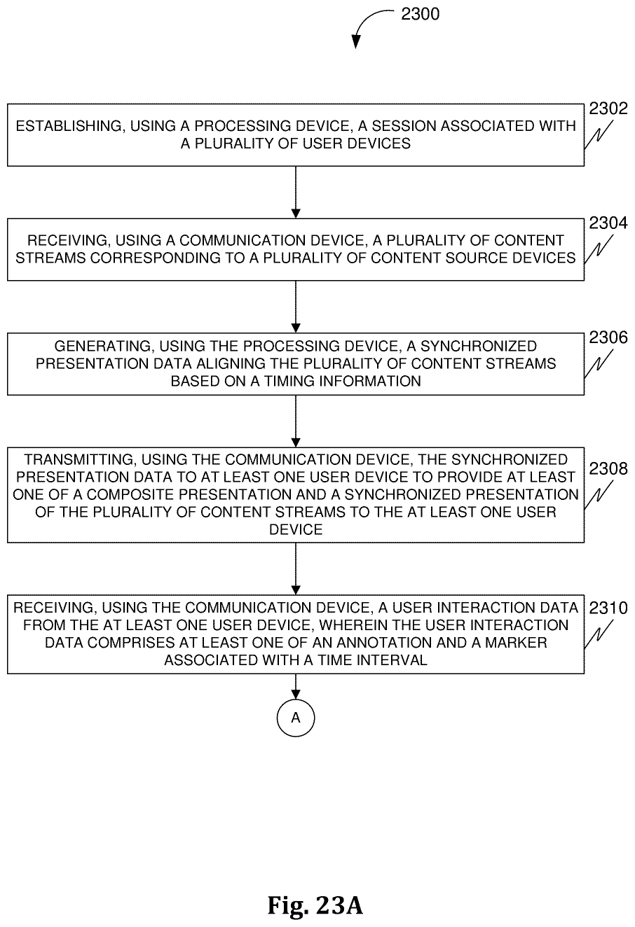

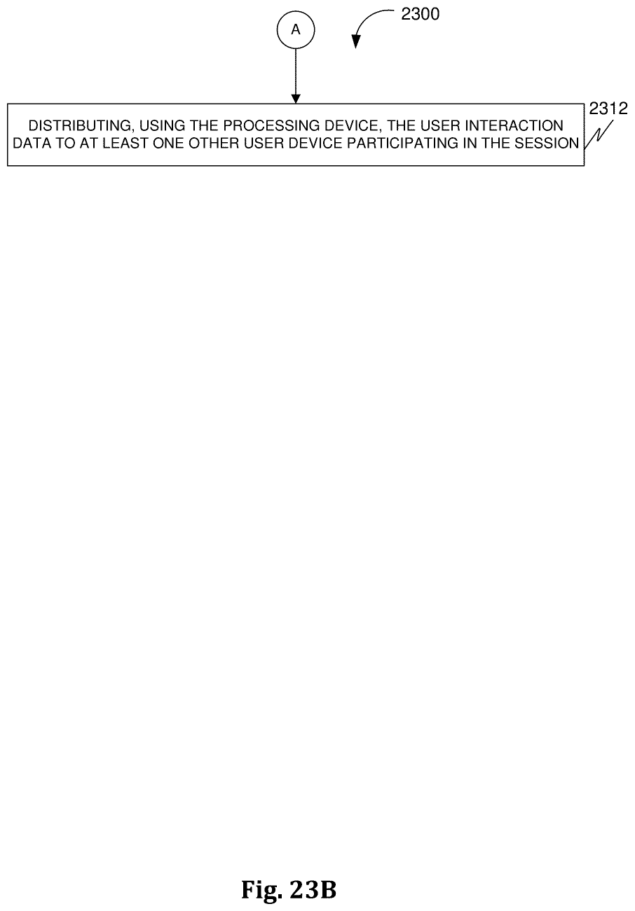

FIG. 23A and FIG. 23B illustrate a flowchart of a method 2300 of providing a multi-stream situation room interface, in accordance with some embodiments. Further, the method 2300 may include a step 2302 of establishing, using a processing device 2404, a session associated with two or more user devices. Further, the method 2300 may include a step 2304 of receiving, using a communication device 2402, two or more content streams corresponding to two or more content source devices 2408. Further, the method 2300 may include a step 2306 of generating, using the processing device 2404, a synchronized presentation data aligning the two or more content streams based on a timing information. Further, the method 2300 may include a step 2308 of transmitting, using the communication device 2402, the synchronized presentation data to one or more user devices 2410 to provide one or more of a composite presentation and a synchronized presentation of the two or more content streams to the one or more user devices 2410. Further, the method 2300 may include a step 2310 of receiving, using the communication device 2402, a user interaction data from the one or more user devices 2410. Further, the user interaction data includes one or more of an annotation and a marker associated with a time interval. Further, the method 2300 may include a step 2312 of distributing, using the processing device 2404, the user interaction data to one or more other user devices participating in the session.

In some embodiments, the aligning of the two or more content streams uses one or more of timestamps and timecodes associated with the two or more content streams.

In some embodiments, the composite presentation includes one or more of a tiled and a picture-in-picture layout.

In some embodiments, the method 2300 may further include generating, using the processing device 404, an alert to a subset of the two or more user devices based on AI-detected events in one or more content streams.

In some embodiments, the distributing of the user interaction data to one or more other user device enforces role-based permissions for one or more of adding and viewing annotations.

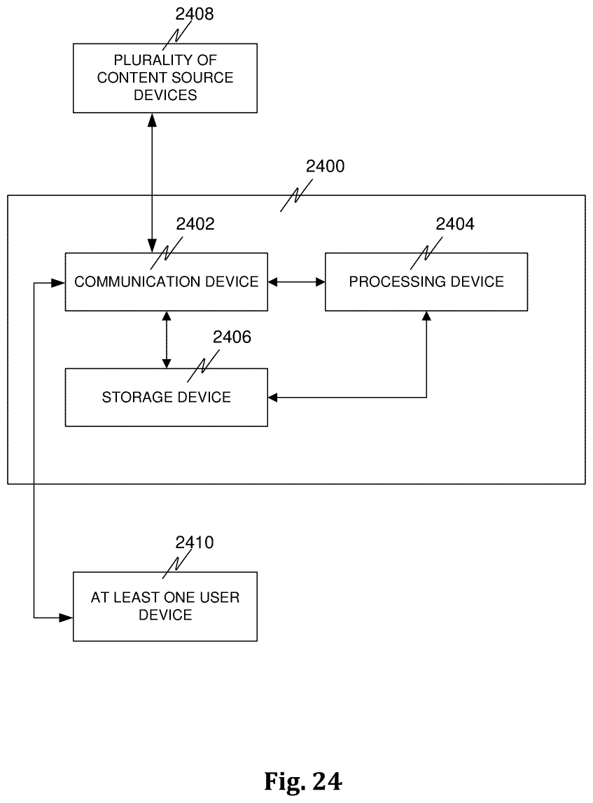

FIG. 24 illustrates a block diagram of a system 2400 for providing a multi-stream situation room interface, in accordance with some embodiments. Further, the system 2400 may include a communication device 2402. Further, the communication device 2402 may be configured for receiving two or more content streams corresponding to two or more content source devices 2408. Further, the communication device 2402 may be configured for transmitting a synchronized presentation data to one or more user devices 2410 to provide one or more of a composite presentation and a synchronized presentation of the two or more content streams to the one or more user devices 2410. Further, the communication device 2402 may be configured for receiving a user interaction data from the one or more user devices 2410. Further, the user interaction data includes one or more of an annotation and a marker associated with a time interval. Further, the system 2400 may include a processing device 2404 communicatively coupled with the communication device 2402. Further, the processing device 2404 may be configured for establishing a session associated with two or more user devices. Further, the processing device 2404 may be configured for generating the synchronized presentation data aligning the two or more content streams based on a timing information. Further, the processing device 2404 may be configured for distributing the user interaction data to one or more other user devices participating in the session. Further, the system 2400 may include a storage device 2406 communicatively coupled with the processing device 2404. Further, the storage device 2406 may be configured for storing the user interaction data as contextual data.

In some embodiments, the processing device 2404 may be further configured for generating an alert to a subset of the two or more user devices based on AI-detected events in one or more content streams.

Although the invention has been explained in relation to its preferred embodiment, it is to be understood that many other possible modifications and variations can be made without departing from the spirit and scope of the invention as hereinafter claimed.

What is claimed is:

1. A method of provisioning digital content, the method comprising:
receiving, using a communication device, a content stream data from at least one content source device, wherein the receiving is performed based on a real-time communication protocol;
generating, using the processing device, an adaptive content stream data based on the at least one content stream data in accordance with an adaptive bitrate streaming protocol; and
transmitting, using the communication device, the adaptive content stream data to at least one user device associated with at least one user.

2. The method of claim 1, wherein the at least one user device is configured for presenting at least one Graphical User Interface, wherein the at least one Graphical User Interface is configured to facilitate an interaction of the at least one user with the adaptive content stream data, wherein the method further comprises generating, using the processing device, at least one user preference data based on the interaction of the at least one user with the adaptive content stream data, wherein the generating of the adaptive content stream data is further based on the at least one user preference data.

3. The method of claim 2, wherein the at least one user preference data comprises at least one user interaction data indicating the interaction of the at least one user with the adaptive content stream data, wherein the method further comprises transmitting, using the communication device, the at least one user interaction data to at least one other user device, wherein the at least one user device and the at least one other user device is associated with a session.

4. The method of claim 1, wherein the receiving of the content stream data comprises receiving a plurality of content stream data from a plurality of content source devices, wherein the method further comprises:
analyzing, using the processing device, the plurality of content stream data; and
determining, using the processing device, a plurality of time information associated with the plurality of content stream data based on the analyzing of the plurality of content stream data, wherein the generating of the adaptive content stream data is further based on the determining of the plurality of time information, wherein the generating of the adaptive content stream data comprises generating a synchronized presentation data based on the plurality of time information, wherein the adaptive content stream data comprises the synchronized presentation data.

5. The method of claim 1 further comprising:
analyzing, using the processing device, at least one of the content stream data and the adaptive content stream data using at least one Artificial Intelligence (AI) agent module;
generating, using the processing device, a control command data using the at least one AI agent module based on the analyzing of at least one of the content stream data and the adaptive content stream data using the at least one AI agent module; and
transmitting, using the communication device, the control command data to the at least one content source device.

6. The method of claim 5 further comprising:
retrieving, using a storage device, a contextual data from a database based on at least one of the content stream data and the adaptive content stream data; and
transmitting, using the communication device, the contextual data to the at least one user device, wherein the transmitting of the contextual data is based on the real-time communication protocol.

7. The method of claim 6, further comprising:
analyzing, using the processing device, each of the content stream data and the contextual data using the at least one AI agent module;
generating, using the processing device, an annotation data using the at least one AI agent module based on the analyzing of each of the content stream data and the contextual data using the at least one AI agent module; and
transmitting, using the communication device, the annotation data to the at least one user device, wherein the transmitting of the annotation data is based on the real-time communication protocol.

8. The method of claim 2 further comprising:
generating, using the processing device, at least one customized adaptive content stream data using the at least one AI agent module based on the at least one user preference data, wherein the at least one customized adaptive content stream data comprises a plurality of content stream data; and
transmitting, using the communication device, the at least one customized adaptive content stream data to the at least one user device, wherein the at least one user device is configured for presenting the at least one customized adaptive content stream data, wherein the presenting of the at least one customized adaptive content stream data provides a composite presentation of the plurality of content stream data.

9. The method of claim 1 further comprising:
receiving, using the communication device, at least one user request data from the at least one user device;
retrieving, using a storage device, at least one recap data from the adaptive content stream data based on the at least one user request data, wherein the adaptive content stream data comprises at least one recorded video data; and
transmitting, using the communication device, the at least one recap data to the at least one user device.

10. The method of claim 9 further comprising:
analyzing, using the processing device, the at least one recap data using the at least one AI agent module;
generating, using the processing device, at least one recap summary data using the at least one AI agent module based on the analyzing of the at least one recap data using the at least one AI agent module; and
transmitting, using the communication device, the at least one recap summary data to the at least one user device.

11. A system for provisioning digital content, the system comprising:
a communication device configured for:
receiving a content stream data from at least one content source device, wherein the receiving is performed based on a real-time communication protocol; and
transmitting an adaptive content stream data to at least one user device associated with at least one user; and
a processing device communicatively coupled with the communication device, wherein the processing device is configured for generating the adaptive content stream data based on the at least one content stream data in accordance with an adaptive bitrate streaming protocol.

12. The system of claim 11, wherein the at least one user device is configured for presenting at least one Graphical User Interface, wherein the at least one Graphical User Interface is configured to facilitate an interaction of the at least one user with the adaptive content stream data, wherein the processing device is further configured for generating at least one user preference data based on the interaction of the at least one user with the adaptive content stream data, wherein the generating of the adaptive content stream data is further based on the at least one user preference data.

13. The system of claim 12, wherein the at least one user preference data comprises at least one user interaction data indicating the interaction of the at least one user with the adaptive content stream data, wherein the communication device is further configured for transmitting the at least one user interaction data to at least one other user device, wherein the at least one user device and the at least one other user device is associated with a session.

14. The system of claim 13, wherein the receiving of the content stream data comprises receiving a plurality of content stream data from a plurality of content source devices, wherein the processing device is further configured for:
analyzing the plurality of content source devices; and
determining a plurality of time information associated with the plurality of content stream data based on the analyzing of the plurality of content source devices, wherein the generating of the adaptive content stream data is further based on the determining of the plurality of time information, wherein the generating of the adaptive content stream data comprises generating a synchronized presentation data based on the plurality of time information, wherein the adaptive content stream data comprises the synchronized presentation data.

15. The system of claim 11, wherein the processing device is further configured for:
analyzing at least one of the content stream data and the adaptive content stream data using at least one Artificial Intelligence (AI) agent module; and
generating a control command data using the at least one AI agent module based on the analyzing of at least one of the content stream data and the adaptive content stream data using the at least one AI agent module, wherein the communication device is further configured for transmitting the control command data to the at least one content source device.

16. The system of claim 15 further comprising a storage device communicatively coupled with the processing device and the communication device, wherein the storage device is configured for retrieving a contextual data from a database based on at least one of the content stream data and the adaptive content stream data, wherein the communication device is further configured for transmitting the contextual data to the at least one user device, wherein the transmitting of the contextual data is based on the real-time communication protocol.

17. The system of claim 16, wherein the processing device is further configured for:
analyzing each of the content stream data and the contextual data using the at least one AI agent module; and
generating an annotation data using the at least one AI agent module based on the analyzing of each of the content stream data and the contextual data using the at least one AI agent module, wherein the communication device is further configured for transmitting the annotation data to the at least one user device, wherein the transmitting of the annotation data is based on the real-time communication protocol.

18. The system of claim 12, wherein the processing device is further configured for generating at least one customized adaptive content stream data using the at least one AI agent module based on the at least one user preference data, wherein the at least one customized adaptive content stream data comprises a plurality of content stream data, wherein the communication device is further configured for transmitting the at least one customized adaptive content stream data to the at least one user device, wherein the at least one user device is configured for presenting the at least one customized adaptive content stream data, wherein the presenting of the at least one customized adaptive content stream data provides a composite presentation of the plurality of content stream data.

19. The system of claim 11, wherein the communication device is further configured for:
receiving at least one user request data from the at least one user device, and
transmitting at least one recap data to the at least one user device, wherein the system further comprises a storage device communicatively coupled with the communication device, wherein the storage device is configured for retrieving the at least one recap data from the adaptive content stream data based on the at least one user request data, wherein the adaptive content stream data comprises at least one recorded video data

20. The system of claim 19, wherein the processing device is further configured for:
analyzing the at least one recap data using the at least one AI agent module; and
generating at least one recap summary data using the at least one AI agent module based on the analyzing of the at least one recap data using the at least one AI agent module, wherein the communication device is further configured for transmitting the at least one recap summary data to the at least one user device.
